(19) United States
(12) Patent Application Publication
(10) Pub. No.: US 2025/0261701 A1
(43) Pub. Date: Aug. 21, 2025

(54) AEROSOL-GENERATING SYSTEM WITH DETECTION OF LIQUID AEROSOL-FORMING SUBSTRATE SUPPLY TO A SUSCEPTOR ELEMENT

(71) Applicant: Philip Morris Products S.A., Neuchatel (CH)

(72) Inventors: Stéphane BILAT, Cortaillod (CH); Oleg MIRONOV, Cudrefin (CH); Enrico STURA, Palézieux-Village (CH)

(73) Assignee: Philip Morris Products S.A., Neuchatel (CH)

(21) Appl. No.: 19/099,704

(22) PCT Filed: Aug. 10, 2023
(86) PCT No.: PCT/EP2023/072259

§ 371 Date: Jan. 29, 2025

(30) Foreign Application Priority Data
Aug. 11, 2022 (EP) 22189965.1

(51) Int. Cl. A24F 40/57; A24F 40/10; A24F 40/465; A24F 40/53; H05B 6/10

(52) U.S. Cl. CPC A24F 40/57; A24F 40/10; A24F 40/465; A24F 40/53; H05B 6/108

(57) ABSTRACT

A power supply circuit for an aerosol-generating device is provided, the aerosol-generating device being configured to heat a susceptor element to generate an aerosol from a liquid aerosol-forming substrate supplied to the susceptor element, the power supply circuit including: an inductor coil configured to generate an alternating magnetic field for heating the susceptor element to generate an aerosol from the liquid aerosol-forming substrate supplied to the susceptor element; a power supply; and a controller configured to: control at least one of a current and a voltage between the power supply and the inductor coil, compare at least one of a current and a voltage between the power supply and the inductor coil to a dry-susceptor threshold, and determine whether the susceptor element is supplied with the liquid aerosol-forming substrate based on the comparison. An aerosol-generating device, an aerosol-generating system, and a method of operating an aerosol-generating device are also provided.

The present disclosure relates to a power supply circuit for an aerosol-generating device, an aerosol-generating device comprising the power supply circuit, an aerosol-generating system comprising the aerosol-generating device, and a method of operating an aerosol-generating device. More specifically, the present disclosure relates to a power supply circuit for an aerosol-generating device that is configured to heat a susceptor element to generate an aerosol from a liquid aerosol-forming substrate supplied to the susceptor element.

Aerosol-generating systems that employ inductive heating to heat a liquid aerosol-forming substrate in order to generate an aerosol for user inhalation are generally known in the prior art. These systems typically comprise an aerosol-generating device including an inductive heating assembly, and a cartridge including a liquid aerosol-forming substrate that is capable of releasing volatile compounds when heated that cools to form an inhalable aerosol. The cartridge is configured to be coupled to the aerosol-generating device. The inductive heating assembly comprises an inductor coil, which is configured to generate an alternating magnetic field. A susceptor element, either forming part of the cartridge or the device, is arranged in close proximity to the aerosol-forming substrate and within the alternating magnetic field. When the susceptor element is penetrated by the alternating magnetic field, the susceptor element is heated by at least one of Joule heating from induced eddy currents in the susceptor element, and hysteresis losses. The heated susceptor element heats liquid aerosol-forming substrate supplied to the susceptor element causing volatile compounds to be released from the liquid aerosol-forming substrate, which cool to form an inhalable aerosol.

Typically, the aerosol-generating device is reusable, and the liquid aerosol-forming substrate is contained in a disposable cartridge. In use, the liquid aerosol-forming substrate is vaporised to generate an aerosol, and after a period of use, for example, a predetermined number of puffs by a user, the liquid aerosol-forming substrate will become depleted. Once the liquid aerosol-forming substrate is depleted, the cartridge should be replaced before subsequent use of the aerosol-generating device.

It would be desirable to provide an aerosol-generating device that is capable of detecting when insufficient liquid aerosol-forming substrate to generate an aerosol is supplied to the susceptor element. It would be desirable to provide an aerosol-generating device that is capable of detecting when the liquid aerosol-forming substrate in the cartridge is depleted.

According to the present disclosure, there is provided a power supply circuit for an aerosol-generating device. The aerosol-generating device is configured to heat a susceptor element to generate an aerosol from a liquid aerosol-forming substrate supplied to the susceptor element. The power supply circuit may comprise an inductor coil for generating an alternating magnetic field for heating the susceptor element to generate an aerosol from the liquid aerosol-forming substrate supplied to the susceptor element. The power supply circuit may further comprise a power supply; and a controller. The controller may be configured to control at least one of a current and a voltage between the power supply and the inductor coil. The controller may be further configured to compare at least one of the current and the voltage between the power supply and the inductor coil to a dry-susceptor threshold. The controller may be further configured to determine whether the susceptor element is supplied with the liquid aerosol-forming substrate based on the comparison.

The inventors have realised that while the susceptor element is supplied with liquid aerosol-forming substrate, the current and the voltage supplied to the inductor coil by the power supply remain substantially constant while the liquid aerosol-forming substrate is being heated and vaporised. Accordingly, a sufficiently large deviation in at least one of the current and the voltage supplied from the power supply to the inductor coil from the constant value achieved while the liquid aerosol-forming substrate is being heated and vaporised may indicate that the susceptor element is not being supplied with liquid aerosol-forming substrate.

Determining whether the susceptor element is supplied with liquid aerosol-forming substrate can be beneficial for several reasons. For example, determining that the susceptor element is not supplied with liquid aerosol-forming substrate may indicate that a reservoir of liquid aerosol-forming substrate is depleted, and requires refilling or replacing. For example, determining that the susceptor element is not supplied with liquid aerosol-forming substrate may indicate that the device is not functioning correctly. For example, determining that the susceptor element is not supplied with liquid aerosol-forming substrate may indicate that the aerosol-generating device is not generating the expected amount or quality of aerosol, as insufficient liquid aerosol-forming substrate is being supplied to the susceptor element.

In some embodiments, the controller is configured to notify a user when it is determined that the susceptor element is not supplied with the liquid aerosol-forming substrate.

The controller may be configured to notify a user in any suitable manner. The controller may be configured to send a notification signal when it is determined that the susceptor element is not supplied with the liquid aerosol-forming substrate. The controller may be configured to provide a visual notification to a user. For example, the controller may be configured to illuminate a light emitting diode to notify a user. The controller may be configured to display a notification on a display. The controller may be configured to provide an audible notification to a user. For example, the controller may be configured to activate a buzzer, or play a sound through a loudspeaker to notify a user.

In some preferred embodiments, the controller is configured to control at least one of the current and the voltage from the power supply to the inductor coil such that power is supplied to the inductor coil to heat a susceptor element coupled to the inductor coil to generate an aerosol from a liquid aerosol-forming substrate supplied to the susceptor element.

The controller may be configured to control at least one of the current and the voltage from the power supply to the inductor coil such that a power of between about 6 Watts and about 12 Watts is supplied to the inductor coil. The controller may be configured to control at least one of the current and the voltage from the power supply to the inductor coil such that a power of between about 8 Watts and about 10 Watts is supplied to the inductor coil.

In some of these preferred embodiments, the controller is further configured to prevent the current being supplied from the power supply to the inductor coil when it is determined that the susceptor element is not supplied with the liquid aerosol-forming substrate.

The controller may be configured to control at least one of a current and a voltage between the power supply and the inductor coil. In some embodiments, the controller is configured to control a voltage between the power supply and the inductor coil. In some preferred embodiments, the controller is configured to control a current between the power supply and the inductor coil.

In some embodiments, the controller is configured to measure the voltage between the power supply and the inductor coil.

In some preferred embodiments, the controller is configured to measure the current between the power supply and the inductor coil.

The controller may be configured to measure the voltage and the current between the power supply and the inductor coil.

The voltage may be any suitable voltage. The voltage may be the supply voltage from the power supply. Preferably the power supply is a DC power supply, and the voltage is the DC supply voltage from the DC power supply. In some preferred embodiments, the power supply electronics may comprise a DC/DC converter. The DC/DC converter may receive the DC supply voltage from the DC power supply. The output of the DC/DC converter may be received by the DC/AC converter. The voltage may be the output of the DC/DC converter.

The current may be any suitable current. In some preferred embodiments, as described in more detail below, the power supply electronics may comprise a DC/AC converter, and the current may comprise the DC current received by the DC/AC converter.

The controller may be configured to compare are least one of the current and the voltage between the power supply and the inductor coil to a dry-susceptor threshold. The dry-susceptor threshold may be any suitable threshold. The dry-susceptor threshold may be a threshold stored in a memory of the controller.

In some embodiments, the dry-susceptor threshold is recorded in the memory of the controller at the factory before the aerosol-generating device is used.

In some preferred embodiments, the dry-susceptor threshold is determined by the power supply circuitry and stored in a memory of the controller. Where the dry-susceptor threshold is determined, the controller may be configured to measure at least one of an initial current and an initial voltage between the power supply and the inductor coil and determine the dry-susceptor threshold based on the at least one of the measured initial current and the measured initial voltage. The measurement of the at least one of the initial current and the initial voltage may occur at any suitable time. The measurement of the at least one of the initial current and the initial voltage may occur when the aerosol-generating device is first turned on. The measurement of the at least one of the initial current and the initial voltage may occur when the aerosol-generating device is first turned on. The measurement of the at least one of the initial current and the initial voltage may occur when a first puff is taken on the aerosol-generating device. Where the aerosol-generating system comprises an aerosol-generating device and a cartridge couplable to the aerosol-generating device, the measurement of the at least one of the initial current and the initial voltage may occur when the cartridge is first coupled to the aerosol-generating device.

In some embodiments, the dry-susceptor threshold is a maximum threshold, above which it may be determined that the susceptor element is not supplied with liquid aerosol-forming substrate.

In some embodiments, the dry-susceptor threshold is a minimum threshold, below which it may be determined that the susceptor element is not supplied with liquid aerosol-forming substrate.

The comparison of the at least one of the current and the voltage between the power supply and the inductor coil to the dry-susceptor threshold may be a comparison of the voltage between the power supply and the inductor coil and the dry-susceptor threshold. The comparison of the at least one of the current and the voltage between the power supply and the inductor coil to the dry-susceptor threshold may be a comparison of the current between the power supply and the inductor coil and the dry-susceptor threshold. The comparison of the at least one of the current and the voltage between the power supply and the inductor coil to the dry-susceptor threshold may be a comparison of both the current and the voltage between the power supply and the inductor coil and the dry-susceptor threshold.

The controller may be further configured to determine whether the susceptor element is supplied with the liquid aerosol-forming substrate based on the comparison.

In some embodiments, the controller may be configured to determine that the susceptor element is not supplied with the liquid aerosol-forming substrate when the at least one of the current and the voltage between the power supply and the inductor coil is greater than the dry-susceptor threshold. In some embodiments, the controller may be configured to determine that the susceptor element is not supplied with the liquid aerosol-forming substrate when the at least one of the current and the voltage between the power supply and the inductor coil is less than the dry-susceptor threshold.

The determination that the susceptor element is not supplied with the liquid aerosol-forming substrate may be dependent on the properties of the susceptor element. However, typically for susceptors comprising materials with a positive temperature coefficient, a comparison of the current between the power supply and the inductor coil to the inductor coil would indicate that the susceptor element is not supplied with the liquid aerosol-forming substrate when the current between the power supply is less than the dry-susceptor threshold.

Where the dry-susceptor threshold is based on a measurement of an initial current between the power supply and the inductor coil, the dry-susceptor threshold may be at least 20 percent less than the measurement of the initial current. The dry-susceptor threshold may be between 15 percent and 50 percent less than the measurement of the initial current.

In some preferred embodiments, the controller is further configured to determine an equivalent resistance or an apparent resistance. As used herein, references to “resistance” refer to electrical, ohmic resistances, unless explicitly indicated otherwise.

The controller may be configured to determine an equivalent resistance from the quotient of the voltage and the current between the power supply and the inductor coil. The equivalent resistance comprises the resistance of the inductor coil and the apparent resistance of the susceptor element. The apparent resistance of the susceptor element is the additional resistance that is “seen” by the inductor coil when the susceptor element is coupled to the inductor coil. The apparent resistance of the susceptor element may be determined by subtracting the resistance of the coil from the equivalent resistance determined from the quotient of the voltage and the current between the power supply and the inductor coil.

In some of these preferred embodiments, the controller may be configured to compare the determined equivalent resistance to the dry-susceptor threshold. In some of these preferred embodiments, the controller may be configured to compare the determined apparent resistance of the susceptor element to the dry-susceptor threshold. In these preferred embodiments, the dry-susceptor threshold may be at least 1.05 ohms. The dry-susceptor threshold may be between about 1.05 ohms and 2.20 ohms.

In some embodiments, the controller is configured to control at least one of the current and the voltage between the power supply and the inductor coil corresponding to a target equivalent resistance, or a target apparent resistance of the susceptor element. In these embodiments, the controller may be configured to determine the equivalent resistance, or the apparent resistance of the susceptor element, and control at least one of the current and the voltage between the power supply and the inductor coil to achieve the target equivalent resistance, or the target apparent resistance of the susceptor element. The target equivalent resistance or the target apparent resistance of the susceptor element may be between about 0.25 ohms and about 1.7 ohms.

In these embodiments, the dry-susceptor threshold may be at least 15 percent greater than the target equivalent resistance, or the target apparent resistance of the susceptor element. The dry-susceptor threshold may be at least 20 percent greater than the target equivalent resistance, or the target apparent resistance of the susceptor element. The dry-susceptor threshold may be between 15 percent and 50 percent greater than the target equivalent resistance, or the target apparent resistance of the susceptor element.

As mentioned above, the determination that the susceptor element is not supplied with the liquid aerosol-forming substrate may be dependent on the properties of the susceptor element. However, typically for susceptors comprising materials with a positive temperature coefficient, a comparison of the determined equivalent resistance to the dry-susceptor threshold would indicate that the susceptor element is not supplied with the liquid aerosol-forming substrate when the determined equivalent resistance is greater than the dry-susceptor threshold.

Where the dry-susceptor threshold is based on a measurement of at least one of an initial current and an initial voltage between the power supply and the inductor coil, the controller may be configured to determine an initial equivalent resistance, or an initial apparent resistance of the susceptor element from the measurement of the at least one of the initial current and the initial voltage. Where the controller is configured to compare a determined equivalent resistance, or apparent resistance of the susceptor element, with the dry susceptor threshold, the dry-susceptor threshold may be at least 20 percent greater than the determined initial equivalent resistance or the determined initial apparent resistance of the susceptor element. The dry-susceptor threshold may be between 15 percent and 50 percent greater than the determined initial equivalent resistance or the determined initial apparent resistance of the susceptor element.

In some preferred embodiments, the controller is further configured to determine an equivalent conductance or an apparent conductance. The controller may be configured to determine an equivalent conductance from the quotient of the current and the voltage between the power supply and the inductor coil. The equivalent conductance comprises the conductance of the inductor coil and the apparent conductance of the susceptor element. The apparent conductance of the susceptor element is the change in conductance that is “seen” by the inductor coil when the susceptor element is coupled to the inductor coil. The apparent conductance of the susceptor element may be determined by subtracting the conductance of the coil from the equivalent conductance determined from the quotient of the current and the voltage between the power supply and the inductor coil.

In some of these preferred embodiments, the controller may be configured to compare the determined equivalent conductance to the dry-susceptor threshold. In some of these preferred embodiments, the controller may be configured to compare the determined apparent conductance of the susceptor element to the dry-susceptor threshold. In these preferred embodiments, the dry-susceptor threshold may be no less than 0.95 siemens. The dry-susceptor threshold may be is between about 0.70 siemens and about 0.95 siemens.

In some embodiments, the controller is configured to control at least one of the current and the voltage between the power supply and the inductor coil corresponding to a target equivalent conductance, or a target apparent conductance of the susceptor element. In these embodiments, the controller may be configured to determine the equivalent conductance, or the apparent conductance of the susceptor element, and control at least one of the current and the voltage between the power supply and the inductor coil to achieve the target equivalent conductance, or the target apparent conductance of the susceptor element. The target equivalent conductance or the target apparent conductance of the susceptor element is between about 0.60 siemens and about 4.00 siemens.

In these embodiments, the dry-susceptor threshold may be at least 15 percent less than the target equivalent conductance, or the target apparent conductance of the susceptor element. The dry-susceptor threshold may be at least 20 percent less than the target equivalent conductance, or the target apparent conductance of the susceptor element. The dry-susceptor threshold may be between 15 percent and 50 percent less than the target equivalent conductance, or the target apparent conductance of the susceptor element.

As mentioned above, the determination that the susceptor element is not supplied with the liquid aerosol-forming substrate may be dependent on the properties of the susceptor element. However, typically for susceptors comprising materials with a positive temperature coefficient, a comparison of the determined equivalent conductance to the dry-susceptor threshold would indicate that the susceptor element is not supplied with the liquid aerosol-forming substrate when the determined equivalent resistance is less than the dry-susceptor threshold.

Where the dry-susceptor threshold is based on a measurement of at least one of an initial current and an initial voltage between the power supply and the inductor coil, the controller may be configured to determine an initial equivalent conductance, or an initial apparent conductance of the susceptor element, from the measurement of the at least one of the initial current and the initial voltage. Where the controller is configured to compare a determined equivalent conductance, or a determined initial apparent conductance of the susceptor element, with the dry susceptor threshold, the dry-susceptor threshold may be at least 20 percent less than the determined initial equivalent conductance, or the determined initial apparent conductance of the susceptor element. The dry-susceptor threshold may be between 15 percent and 50 percent less than the determined initial equivalent conductance or the determined initial apparent conductance of the susceptor element.

The power supply circuit comprises an inductor coil.

The inductor coil may have any suitable form. In some embodiments, the inductor coil is a tubular coil. In some embodiments, the inductor coil is a helical coil. In some embodiments, the inductor coil is a planar coil or a flat coil.

The power supply circuit may further comprise at least one flux concentrator arranged to contain the alternating magnetic field generated by the inductor coil.

The power supply circuit may comprise any suitable number of inductor coils. The power supply circuit may comprise a single inductor coil. The power supply circuit may comprise a plurality of inductor coils. The power supply circuit may comprise one, two, three, four, five, six, seven, or eight inductor coils.

The power supply may be any suitable power supply. Preferably, the power supply is a DC power supply. The power supply may be a battery. The battery may be a Lithium based battery, for example a Lithium-Cobalt, a Lithium-Iron-Phosphate, a Lithium Titanate, or a Lithium-Polymer battery. The battery may be a Nickel-metal hydride battery or a Nickel cadmium battery. The power supply may be another form of charge storage device such as a capacitor. The power supply may be rechargeable and be configured for many cycles of charge and discharge. The power supply may have a capacity that allows for the storage of enough energy for one or more user experiences of the aerosol-generating system; for example, the power supply may have sufficient capacity to allow for the continuous generation of aerosol for a period of around six minutes, corresponding to the typical time taken to smoke a conventional cigarette, or for a period that is a multiple of six minutes. In another example, the power supply may have sufficient capacity to allow for a predetermined number of puffs or discrete activations of the atomiser assembly.

The controller may be any suitable controller. The controller may comprise a memory. The dry-susceptor threshold may be stored in the memory of the controller. The controller may comprise a microprocessor. The microprocessor may be a programmable microprocessor, a microcontroller, or an application specific integrated chip (ASIC) or other electronic circuitry capable of providing control. The controller may be configured to supply power to the inductor coil continuously following activation of the device, or may be configured to supply power intermittently, such as on a puff-by-puff basis. The power may be supplied to the inductor coil in the form of pulses of electrical current, for example, by means of pulse width modulation (PWM).

The controller may be configured to supply an alternating current to the inductor coil. As used herein, an “alternating current” means a current that periodically reverses direction. The alternating current may have any suitable frequency. Suitable frequencies for the alternating current may be between 100 kilohertz (kHz) and 30 megahertz (MHz). Where the inductor coil is a helical coil, or a tubular coil, the alternating current may have a frequency of between 500 kilohertz (kHz) and 30 megahertz (MHz). Where the inductor coil is a flat coil, the alternating current may have a frequency of between 100 kilohertz (kHz), and 1 megahertz (MHz).

Driving an alternating current through the inductor coil causes the inductor coil to generate an alternating magnetic field. The alternating magnetic field may have any suitable frequency for heating a heating portion of a susceptor element located in the alternating magnetic field. Suitable frequencies for the alternating magnetic field may be between 100 kilohertz (kHz) and 30 megahertz (MHz).

The power supply circuit may comprise further electronic components. For example, in some embodiments, the controller may comprise any of: sensors, switches, display elements.

Where the power supply is a DC power supply, the power supply circuit may further comprise a DC/AC converter. The DC/AC converter may be arranged between the DC power supply and the inductor coil. The DC/AC converter may comprise a capacitor. The DC/AC converter may comprise a LC (inductor capacitor) load network.

In some preferred embodiments, the DC/AC converter may comprise a capacitor, wherein the DC/AC converter further comprises a LC (inductor capacitor) load network, and wherein the LC load network comprises the inductor coil and the capacitor. In some of these preferred embodiments, the inductor coil is connected in series with the capacitor.

In some preferred embodiments, the DC/AC converter comprises a Class-E power amplifier. The DC/AC converter may comprise a Class-D power amplifier.

In some embodiments, the power supply circuit may further comprise a DC/DC converter. The DC/DC converter may be arranged between the DC power supply and the DC/AC converter. The DC/DC converter may enable DC power supplies with different supply voltages to be used with the aerosol-generating device without altering the functioning of the aerosol-generating device.

The power supply circuit may further comprise a puff detector. The puff detector may be configured to detect when a user draws on the aerosol-generating device. The puff detector may be any suitable sensor that is capable of detecting when a user draws on the aerosol-generating device. For example, the puff detector may be an airflow sensor.

Where the power supply circuit comprises a puff detector, the controller may be configured to supply the current and the voltage to the inductor coil to generate the alternating magnetic field to heat the susceptor element and generate the aerosol when the puff detector detects a user drawing on the aerosol-generating device. The controller may be further configured to prevent the supply of the current and the voltage to the inductor coil to generate the alternating magnetic field to heat the susceptor element and generate the aerosol when it is determined that the susceptor element is not supplied with the liquid aerosol-forming substrate.

There is also provided an aerosol-generating device configured to heat a susceptor element to generate an aerosol from a liquid aerosol-forming substrate supplied to the susceptor element, wherein the aerosol-generating device comprises a power supply circuit as described above.

It is envisioned that there may be provided an aerosol-generating device configured to heat a susceptor element to generate an aerosol from a liquid aerosol-forming substrate supplied to the susceptor element, the aerosol-generating device being couplable to a cartridge comprising the susceptor element. The aerosol-generating device may comprise a power supply circuit comprising an inductor coil for generating an alternating magnetic field for heating the susceptor element to generate an aerosol from the liquid aerosol-forming substrate supplied to the susceptor element. The power supply circuit may further comprise a power supply; and a controller. The controller may be configured to control at least one of a current and a voltage between the power supply and the inductor coil. The controller may be further configured to compare at least one of the current and the voltage between the power supply and the inductor coil to a dry-susceptor threshold. The controller may be further configured to determine whether the susceptor element is supplied with the liquid aerosol-forming substrate based on the comparison.

In some preferred embodiments, the aerosol-generating device may further comprise a cavity configured to receive a portion of a cartridge to couple the cartridge to the aerosol-generating device. In some of these preferred embodiments, the inductor coil is arranged at or around the cavity. Preferably, the inductor coil is arranged to generate the alternating magnetic field in the cavity. The inductor coil may at least partially circumscribe the cavity.

There is also provided an aerosol-generating system comprising an aerosol-generating device having a power supply circuit as described above, and a cartridge comprising a liquid reservoir for holding a liquid aerosol-forming substrate. In some embodiments, the aerosol-generating device comprises the susceptor element. In some preferred embodiments, the cartridge comprises the susceptor element.

In particular, there is provided an aerosol-generating system comprising: a cartridge having a susceptor element and a liquid aerosol-forming substrate supplied to the susceptor element; and an aerosol-generating device as described above, having a power supply circuit as described above.

It is envisioned that there may be provided an aerosol-generating system comprising: a cartridge; and an aerosol-generating device. The cartridge may comprise: a susceptor element; and a liquid aerosol-forming substrate supplied to the susceptor element. The aerosol-generating device may be couplable to the cartridge. The aerosol-generating device may be configured to heat the susceptor element to generate an aerosol from the liquid aerosol-forming substrate supplied to the susceptor element. The aerosol-generating device may comprise a power supply circuit. The power supply circuit may comprise an inductor coil for generating an alternating magnetic field for heating the susceptor element to generate an aerosol from the liquid aerosol-forming substrate supplied to the susceptor element. The power supply circuit may further comprise: a power supply; and a controller. The controller may be configured to control at least one of a current and a voltage between the power supply and the inductor coil. The controller may be further configured to compare at least one of the current and the voltage between the power supply and the inductor coil to a dry-susceptor threshold. The controller may be further configured to determine whether the susceptor element is supplied with the liquid aerosol-forming substrate based on the comparison.

As used herein, a “susceptor element” means an element that is heatable by penetration with an alternating magnetic field. A susceptor element is typically heatable by at least one of Joule heating, through induction of eddy currents in the susceptor element, and hysteresis losses.

Possible materials for the susceptor element include graphite, molybdenum, silicon carbide, stainless steels, niobium, aluminium and virtually any other conductive elements. The susceptor element may be a ferrite element. The material and the geometry for the susceptor element may be chosen to provide a desired electrical resistance and heat generation.

The susceptor element may comprise a magnetic material heatable by penetration with an alternating magnetic field. The term “magnetic material” is used herein to describe a material which is able to interact with a magnetic field, including both paramagnetic and ferromagnetic materials. The magnetic material may be any suitable magnetic material that is heatable by penetration with an alternating magnetic field. In some preferred embodiments, the magnetic material comprises a ferritic stainless steel. Suitable ferritic stainless steels include SAE 400 series stainless steels, such as SAE type 409, 410, 420 and 430 stainless steels.

The susceptor element may have any suitable form. The susceptor element may comprise, for example, a mesh, flat spiral coil, fibres, or a fabric. The susceptor element may be fluid permeable.

In some preferred embodiments, the susceptor element is planar. The planar susceptor element may extend substantially in a plane.

In some preferred embodiments, the susceptor element comprises a mesh. The susceptor element may comprise an array of filaments forming a mesh. As used herein the term “mesh” encompasses grids and arrays of filaments having spaces therebetween. The term mesh also includes woven and non-woven fabrics.

The filaments may define interstices between the filaments and the interstices may have a width of between 10 micrometres and 100 micrometres. Preferably the filaments give rise to capillary action in the interstices, so that in use, the source liquid is drawn into the interstices, increasing the contact area between the susceptor element and the liquid.

The filaments may form a mesh of size between 160 and 600 Mesh US (+/−10%) (i.e. between 160 and 600 filaments per inch (+/−10%)). The width of the interstices may be between 35 micrometres and 140 micrometres, or between 25 micrometres and 75 micrometres. For example, the width of the interstices may be 40 micrometres, or 63 micrometres. The percentage of open area of the mesh, which is the ratio of the area of the interstices to the total area of the mesh is preferably between 25 and 56%. The mesh may be formed using different types of weave or lattice structures. Alternatively, the filaments consist of an array of filaments arranged parallel to one another.

The filaments may be formed by etching a sheet material, such as a foil. This may be particularly advantageous when the heater assembly comprises an array of parallel filaments. If the heating element comprises a mesh or fabric of filaments, the filaments may be individually formed and knitted together.

Preferably, the mesh is sintered. The filaments of the mesh may be sintered together. Advantageously, sintering the mesh creates electrical bonds between filaments extending in different directions. In particular, where the mesh comprises one or more of woven and non-woven fabrics, it is advantageous for the mesh to be sintered to create electrical bonds between overlapping filaments.

The mesh may also be characterised by its ability to retain liquid, as is well understood in the art.

The filaments of the mesh may have a diameter of between 8 micrometres and 100 micrometres, between 30 micrometres and 100 micrometres, between 8 micrometres and 50 micrometres, or between 8 micrometres and 39 micrometres. The filaments of the mesh may have a diameter of 50 micrometres.

The filaments of the mesh may have any suitable cross-section. For example, the filaments may have a round cross section or may have a flattened cross-section.

Advantageously, the mesh susceptor element may have a relative permeability between 1 and 40000. When a reliance on eddy currents for a majority of the heating is desirable, a lower permeability material may be used, and when hysteresis effects are desired then a higher permeability material may be used. Preferably, the material has a relative permeability between 500 and 40000. This may provide for efficient heating of the susceptor element.

The aerosol-generating system comprises a cartridge. The cartridge may be couplable to the aerosol-generating device.

The cartridge comprises a liquid reservoir. Preferably, the cartridge further comprises the susceptor element. In some preferred embodiments, in which the cartridge comprises the susceptor element, and the aerosol-generating device comprises a cavity configured to receive a portion of the cartridge to couple the cartridge to the aerosol-generating device, the susceptor element is arranged in the cartridge at a position that is received in the cavity of the aerosol-generating device when the cartridge is coupled to the aerosol-generating device.

Where the aerosol-generating system comprises a cartridge including the susceptor element, the inductor coil may be arranged in the device such that the alternating magnetic field penetrates the cartridge, and particularly the susceptor element in the cartridge, when the cartridge is coupled to the aerosol-generating device. Where the aerosol-generating device comprises a cavity for receiving the cartridge, the inductor coil may be arranged such that the alternating magnetic field penetrates the cavity. The inductor coil may be arranged at the cavity, in the cavity, or around the cavity. In some embodiments, the inductor coil may circumscribe the cavity. The inductor coil may be a tubular, spiral, or helical coil that substantially circumscribes the cavity. In other embodiments, the coil may be arranged at a side of the cavity.

In some embodiments where the susceptor element is planar and extends parallel to a plane, the inductor coil may be arranged to generate an alternating magnetic field that penetrates the susceptor assembly in a direction substantially parallel to the plane.

In some embodiments where the susceptor element is planar and extends parallel to a plane, the inductor coil may be arranged to generate an alternating magnetic field that penetrates the susceptor assembly in a direction substantially perpendicular to the plane.

A tubular or helical inductor coil may circumscribe the susceptor element. A planar or flat inductor coil may be arranged at one side of the susceptor element. A planar or flat inductor coil may be circular, elliptical, or rectangular. Preferably the shape of the planar or flat inductor coil substantially corresponds to the shape of the susceptor element.

Where the susceptor element is substantially planar, extending parallel to a first plane, the inductor coil may be a flat inductor coil extending in a second plane, substantially parallel to the first plane. In this arrangement, the inductor coil is arranged to generate an alternating magnetic field that penetrates the susceptor assembly in a direction substantially perpendicular to the first plane.

In some preferred embodiments, the susceptor assembly comprises a planar susceptor element, and the power supply circuitry comprises a first flat inductor coil and a second flat inductor coil. The planar susceptor element extends in a first plane, the first inductor coil extends in a second plane, parallel to the first plane, and the second inductor coil extends in a third plane, parallel to the first and second planes. The susceptor element is arranged between the first inductor coil and the second inductor coil. In this arrangement, the first inductor coil generates an alternating magnetic field that penetrates the susceptor element from a first side in a direction substantially perpendicular to the first plane, and the second inductor coil generates an alternating magnetic field that penetrates the susceptor assembly from a second side, opposite the first side, in a direction substantially perpendicular to the first plane. Advantageously, such an arrangement may provide efficient, uniform heating of the susceptor element. In these preferred embodiments, the inductive heating assembly is configured such that the first and second inductor coils generate alternating magnetic fields of similar magnitudes, in opposite directions.

In some of these preferred embodiments, the first and second inductor coils may be electrically connected to form a single conductive path. In these embodiments, the first inductor coil may be wound in opposite sense to the second inductor coil, such that the alternating magnetic fields generated by the first and second inductor coils are generated in opposing directions. Alternatively, the first and second inductor coil may be wound in the same sense, and the controller may be configured to supply alternating currents to each of the first and second inductor coils such that the alternating magnetic fields generated by the first and second inductor coils are generated in opposing directions. The first and second inductor coils may be substantially identical. The first and second inductor coils may be substantially identical but wound in opposite senses.

The cartridge comprises a liquid reservoir. The liquid reservoir is configured to hold a liquid aerosol-forming substrate. In particular, the liquid reservoir is configured to hold the liquid aerosol-forming substrate supplied to the susceptor element. The liquid reservoir may have any suitable shape and size depending on the requirements of the aerosol-generating system.

In some embodiments, the liquid reservoir contains a retention material for holding a liquid aerosol-forming substrate. Where the liquid reservoir comprises a plurality of portions, the retention material may be positioned in one or more of the portions, or in all of the portions. The retention material may be a foam material, a sponge material, or a collection of fibres. The retention material may be formed from a polymer or co-polymer. In one embodiment, the retention material is a spun polymer.

Where the cartridge comprises a wicking element and a retention material, the wicking element and the retention material may be formed from the same material, or different materials. The retention material may be in fluid communication with the susceptor assembly. The retention material may contact the susceptor assembly. The retention material may be in fluid contact with a wicking element of the susceptor assembly. The retention material may contact a wicking element of the susceptor assembly.

In some embodiments, the cartridge comprises a susceptor assembly. The susceptor assembly comprises the susceptor element. The susceptor assembly may further comprise a liquid transfer element. The liquid transfer element may be in fluid communication with the susceptor element. The liquid transfer element may be in fluid communication with the liquid reservoir. The liquid transfer element may be arranged to convey liquid aerosol-forming substrate from the liquid reservoir to the susceptor element. In particular, the liquid transfer element may be arranged to convey liquid aerosol-forming substrate from the liquid reservoir across a major surface of the susceptor element. The susceptor element may be fixed to the liquid transfer element. The susceptor element may be integral with the liquid transfer element. The provision of a liquid transfer element may improve the wetting of the susceptor element, and so increase aerosol generation by the system.

In some preferred embodiments, the liquid transfer element is a wicking element. A wicking element may allow the susceptor element to be made from materials that do not themselves provide good wicking or wetting performance.

The susceptor assembly may comprise a plurality of susceptor elements. Where the susceptor assembly comprises a plurality of susceptor elements and a liquid transfer element, each susceptor element may be arranged in fluid communication with the liquid transfer element. The susceptor assembly may comprise a plurality of susceptor elements, and a plurality of wicking elements.

In some preferred embodiments, the susceptor assembly comprises a first susceptor element, and a second susceptor element, the second susceptor element being spaced apart from the first susceptor element. A wicking element may be arranged in the space between the first susceptor element and the second susceptor element. In some particularly preferred embodiments, the first susceptor element, second susceptor element, and wicking element are substantially planar, and the first susceptor element is arranged at a first side of the planar wicking element, and the second susceptor element is arranged at a second side of the planar wicking element, opposite the first side.

The susceptor assembly may comprises a heating region and at least one mounting region. The heating region is a region of the susceptor assembly is a region that is configured to be heated to a temperature required to vaporise the aerosol-forming substrate upon penetration by a suitable alternating magnetic field. The at least one mounting region of the susceptor assembly is a region that is configured to contact a housing or a susceptor element holder of the cartridge. In some preferred embodiments, the at least one mounting region extends into the liquid reservoir.

Where the liquid transfer assembly comprises a wicking element, the wicking element may comprise a capillary material. A capillary material is a material that is capable of transport of liquid from one end of the material to another by means of capillary action. The capillary material may have a fibrous or spongy structure. The capillary material preferably comprises a bundle of capillaries. For example, the capillary material may comprise a plurality of fibres or threads or other fine bore tubes. The fibres or threads may be generally aligned to convey liquid aerosol-forming substrate towards the susceptor element. In some embodiments, the capillary material may comprise sponge-like or foam-like material. The structure of the capillary material may form a plurality of small bores or tubes, through which the liquid aerosol-forming substrate can be transported by capillary action. Where the susceptor element comprises interstices or apertures, the capillary material may extend into interstices or apertures in the susceptor element. The susceptor element may draw liquid aerosol-forming substrate into the interstices or apertures by capillary action.

The wicking element may comprise an electrically insulative material. The wicking element may comprise a thermally insulative material. The wicking element may comprise a hydrophilic material. The wicking element may comprise an oleophilic material. Advantageously, forming the wicking element from a hydrophilic or an oleophilic material may encourage the transport of the aerosol-forming substrate through the wicking element.

The wicking element may comprise a non-metallic material. Examples of suitable materials for the wicking element are sponge or foam materials, ceramic- or graphite-based materials in the form of fibres or sintered powders, foamed metal or plastics materials, fibrous materials, for example made of spun or extruded fibres, such as cellulose acetate, polyester, or bonded polyolefin, polyethylene, terylene or polypropylene fibres, nylon fibres or ceramic fibres or glass fibres. Suitable materials for the wicking element may comprise cellulosic materials, such as cotton or rayon. Preferably, the wicking element may comprise rayon. The wicking element may consist of rayon. Wicking elements comprising porous ceramic materials may be particularly advantageous when one or both of the susceptor elements comprise an electrically conductive material deposited on the wicking element. A wicking element comprising a porous ceramic material may be an advantageous substrate for the manufacturing processes associated with the deposition of the electrically conductive material.

The cartridge may comprise an aerosol-forming substrate. As used herein, the term “aerosol-forming substrate” refers to a substrate capable of releasing volatile compounds that can form an aerosol. Volatile compounds may be released by heating the aerosol-forming substrate. Preferably, the cartridge contains a liquid aerosol-forming substrate.

The aerosol-forming substrate may be liquid at room temperature. The aerosol-forming substrate may comprise both liquid and solid components. The liquid aerosol-forming substrate may comprise nicotine. The nicotine containing liquid aerosol-forming substrate may be a nicotine salt matrix. The liquid aerosol-forming substrate may comprise plant-based material. The liquid aerosol-forming substrate may comprise tobacco. The liquid aerosol-forming substrate may comprise a tobacco-containing material containing volatile tobacco flavour compounds, which are released from the aerosol-forming substrate upon heating. The liquid aerosol-forming substrate may comprise homogenised tobacco material. The liquid aerosol-forming substrate may comprise a non-tobacco-containing material. The liquid aerosol-forming substrate may comprise homogenised plant-based material.

The liquid aerosol-forming substrate may comprise one or more aerosol-formers. An aerosol-former is any suitable known compound or mixture of compounds that, in use, facilitates formation of a dense and stable aerosol and that is substantially resistant to thermal degradation at the temperature of operation of the system. Examples of suitable aerosol formers include glycerine and propylene glycol. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. The liquid aerosol-forming substrate may comprise water, solvents, ethanol, plant extracts and natural or artificial flavours.

The liquid aerosol-forming substrate may comprise nicotine and at least one aerosol-former. The aerosol-former may be glycerine or propylene glycol. The aerosol former may comprise both glycerine and propylene glycol. The liquid aerosol-forming substrate may have a nicotine concentration of between about 0.5% and about 10%, for example about 2%.

The cartridge may comprise an outer housing. The outer housing may be formed from a durable material. The outer housing may be formed from a liquid impermeable material. The outer housing may be formed form a mouldable plastics material, such as polypropylene (PP) or polyethylene terephthalate (PET).

The susceptor assembly may be arranged in the outer housing. Where the cartridge comprises a susceptor element holder, the susceptor element holder may be arranged in the outer housing. In some embodiments, the susceptor element holder may be integrally formed with the outer housing. The susceptor element holder may be formed from the same material as the outer housing of the cartridge or may be formed from a different material.

The outer housing may define a portion of the liquid reservoir. The outer housing may define the liquid reservoir. The outer housing and the liquid reservoir may be integrally formed. Alternatively, the liquid reservoir may be formed separately from the outer housing and arranged in the outer housing.

The cartridge may have a mouth end through which generated aerosol may be drawn by a user. The cartridge may have a connection end configured to couple the cartridge to an aerosol-generating device.

The cartridge may define an air inlet. The air inlet may be arranged at or around the connection end of the cartridge. The cartridge may define a mouth end opening. A user may be able to draw aerosol generated from the cartridge through the mouth end opening. The cartridge may define an enclosed airflow passage from the air inlet to the air outlet. The enclosed airflow passage may extend from the air inlet, past the susceptor element, to the mouth end opening.

The enclosed airflow passage may pass through the liquid reservoir. For example, the liquid reservoir may have an annular cross-section defining an internal passage, and the airflow passage may extend through the internal passage of the liquid reservoir.

The aerosol-generating device may comprise a housing. The housing may be elongate. The housing may comprise any suitable material or combination of materials. Examples of suitable materials include metals, alloys, plastics, or composite materials containing one or more of those materials, or thermoplastics that are suitable for food or pharmaceutical applications, for example polypropylene, polyetheretherketone (PEEK) and polyethylene. The material is preferably light and non-brittle.

The aerosol-generating device housing may define a cavity for receiving a portion of a cartridge. The aerosol-generating device may comprise one or more air inlets. The one or more air inlets may enable ambient air to be drawn into the cavity.

The aerosol-generating device may have a connection end configured to connect the aerosol-generating device to a cartridge. The connection end may comprise the cavity for receiving the cartridge.

The aerosol-generating device may have a distal end, opposite the connection end. The distal end may comprise an electrical connector configured to connect the aerosol-generating device to an electrical connector of an external power supply, for charging the power supply of the aerosol-generating device.

The aerosol-generating system may be a handheld aerosol-generating system configured to allow a user to puff on a mouthpiece to draw an aerosol through a mouth end opening. The aerosol-generating system may have a size comparable to a conventional cigar or cigarette. The aerosol-generating system may have a total length between about 30 mm and about 150 mm. The aerosol-generating system may have an external diameter between about 5 mm and about 30 mm.

The aerosol-generating system may be configured to deliver nicotine or cannabinoids to a user.

There is also provided a method of operating an aerosol-generating device, the aerosol-generating device comprising a power supply and an inductor coil and being configured to heat a susceptor element to generate an aerosol from a liquid aerosol-forming substrate supplied to the susceptor element. The method may comprise controlling at least one of a current and a voltage between the power supply and the inductor coil. The method may further comprises comparing at least one of the current and the voltage between the power supply and the inductor coil to a dry-susceptor threshold. The method may further comprise determining whether the susceptor element is supplied with the liquid aerosol-forming substrate based on the comparison.

In some embodiments, the method further comprises notifying a user when it is determined that the susceptor element is not supplied with the liquid aerosol-forming substrate.

In some embodiments, the method further comprises preventing the current being supplied from the power supply to the inductor coil when it is determined that the susceptor element is not supplied with the liquid aerosol-forming substrate.

The method may further comprise controlling at least one of the current and the voltage from the power supply to the inductor coil such that a power of between about 6 Watts and about 12 Watts is supplied to the inductor coil. In some embodiments, the current and the voltage from the power supply to the inductor coil are controlled such that a power of between about 8 Watts and about 10 Watts to the inductor coil.

In some preferred embodiments, the method further comprises determining an equivalent resistance, or an apparent resistance of the susceptor element. The equivalent resistance comprises the quotient of the voltage and the current between the power supply and the inductor coil. The apparent resistance of the susceptor element may be determined by subtracting the resistance of the coil from the equivalent resistance determined from the quotient of the voltage and the current between the power supply and the inductor coil.

In some of these preferred embodiments, the comparing at least one of the current and the voltage to the dry-susceptor threshold is a comparison of the equivalent resistance to the dry-susceptor threshold. The dry-susceptor threshold may be at least 1.05 ohms, and optionally may be between about 1.05 ohms and 2.20 ohms.

In some embodiments, the method further comprises controlling at least one of the current and the voltage from the power supply to the inductor coil corresponding to a target equivalent resistance, or a target apparent resistance of the susceptor element. Optionally, the target equivalent resistance, or the target apparent resistance of the susceptor element, may be between about 0.25 ohms and about 1.7 ohms. The dry-susceptor threshold may be at least 15 percent greater than the target equivalent resistance, or the target apparent resistance of the susceptor element. Optionally, the dry-susceptor threshold may be at least 20 percent greater than the target equivalent resistance, or the target apparent resistance of the susceptor element, or between 15 percent and 50 percent greater than the target equivalent resistance, or the target apparent resistance of the susceptor element.

In some embodiments, the method further comprises determining an equivalent conductance, or an apparent conductance of the susceptor element. As mentioned above, the equivalent conductance comprises the quotient of the current and the voltage between the power supply and the inductor coil. The apparent conductance of the susceptor element may be determined by subtracting the conductance of the coil from the equivalent conductance determined from the quotient of the current and the voltage between the power supply and the inductor coil.

In some of these embodiments, the comparing at least one of the current and the voltage to the dry-susceptor threshold is a comparison of the equivalent conductance, or the apparent conductance of the susceptor element to the dry-susceptor threshold. The dry-susceptor threshold may be no less than 0.95 siemens, and optionally may be between about 0.70 siemens and about 0.95 siemens.

In some embodiments, the method further comprises controlling at least one of the current and the voltage from the power supply to the inductor coil corresponding to a target equivalent conductance, or a target apparent conductance of the susceptor element. Optionally, the target equivalent conductance, or the target apparent conductance of the susceptor element, is between about 0.60 siemens and about 4.00 siemens. The dry-susceptor threshold may be at least 15 percent less than the target equivalent conductance, or the target apparent conductance of the susceptor element. Optionally, the dry-susceptor threshold may be at least 20 percent less than the target equivalent conductance, or the target apparent conductance of the susceptor element, or between about 15 percent and about 50 percent less than the target equivalent conductance, or the target apparent conductance of the susceptor element.

In some preferred embodiments, the method further comprises measuring the voltage between the power supply and the inductor coil.

In some preferred embodiments, the method further comprises measuring the current between the power supply and the inductor coil.

In some embodiments, the aerosol-generating device further comprises a puff detector, and the method further comprises detecting when a user draws on the aerosol-generating device using the puff detector. In some of these embodiments, the method further comprises supplying the current and the voltage to the inductor coil to generate the alternating magnetic field to heat the susceptor element and generate the aerosol when the puff detector detects a user drawing on the aerosol-generating device.

In some embodiments, the method further comprises preventing the supply of the current and the voltage to the inductor coil to generate the alternating magnetic field to heat the susceptor element and generate the aerosol when it is determined that the susceptor element is not supplied with the liquid aerosol-forming substrate.

It will be appreciated that any features described herein in relation to one embodiment may also be applicable to other embodiments. A feature described in relation to the power supply circuit may be equally applicable to an aerosol-generating device comprising a power supply circuit, or an aerosol-generating system comprising a power supply circuit.

The invention is defined in the claims. However, below there is provided a non-exhaustive list of non-limiting examples. Any one or more of the features of these examples may be combined with any one or more features of another example, embodiment, or aspect described herein.

1. A power supply circuit for an aerosol-generating device, the aerosol-generating device being configured to heat a susceptor element to generate an aerosol from a liquid aerosol-forming substrate supplied to the susceptor element, the power supply circuit comprising:
an inductor coil for generating an alternating magnetic field for heating the susceptor element to generate an aerosol from the liquid aerosol-forming substrate supplied to the susceptor element;
a power supply; and
a controller, wherein the controller is configured to:
   control at least one of a current and a voltage between the power supply and the inductor coil;
   compare at least one of the current and the voltage between the power supply and the inductor coil to a dry-susceptor threshold; and
   determine whether the susceptor element is supplied with the liquid aerosol-forming substrate based on the comparison.

2. A power supply circuit according to example 1, wherein the controller is further configured to notify a user when it is determined that the susceptor element is not supplied with the liquid aerosol-forming substrate.

3. A power supply circuit according to any one of examples 1 or 2, wherein the controller is further configured to prevent the current being supplied from the power supply to the inductor coil when it is determined that the susceptor element is not supplied with the liquid aerosol-forming substrate.

4. A power supply circuit according to any one of examples 1 to 3, wherein the controller is configured to control at least one of the current and the voltage from the power supply to the inductor coil such that a power of between about 6 Watts and about 12 Watts is supplied to the inductor coil, and optionally to supply between about 8 Watts and about 10 Watts to the inductor coil.

5. A power supply circuit according to any one of examples 1 to 4, wherein the controller is further configured to determine an equivalent resistance, the equivalent resistance being the quotient of the voltage and the current, and wherein the comparison of the at least one of the current and the voltage to the dry-susceptor threshold is a comparison of the equivalent resistance to the dry-susceptor threshold.

6. A power supply circuit according to example 5, wherein the dry-susceptor threshold is at least 1.05 ohms, and optionally is between about 1.05 ohms and 2.20 ohms.

7. A power supply circuit according to example 5 or example 6, wherein the controller is configured to control at least one of the current and the voltage from the power supply to the inductor coil corresponding to a target equivalent resistance, and optionally wherein the target equivalent resistance is between about 0.25 ohms and about 1.7 ohms.

8. A power supply circuit according to example 7, wherein the dry-susceptor threshold is an equivalent resistance at least 15 percent greater than the target equivalent resistance, optionally at least 20 percent great than the target equivalent resistance, and optionally between 15 percent and 50 percent greater than the target equivalent resistance.

9. A power supply circuit according to any one of examples 1 to 4, wherein the controller is further configured to determine an equivalent conductance, the equivalent conductance being the quotient of the current and the voltage, and wherein the comparison of the at least one of the current and the voltage to a dry-susceptor threshold is a comparison of the equivalent conductance to the dry-susceptor threshold.

10. A power supply circuit according to example 9, wherein the dry-susceptor threshold is no less than 0.95 siemens, and optionally is between about 0.70 siemens and about 0.95 siemens.

11. A power supply circuit according to example 9 or example 10, wherein the controller is configured to control at least one of the current and the voltage from the power supply to the inductor coil corresponding to a target equivalent conductance, and optionally wherein the target equivalent conductance is between about 0.60 siemens and about 4.00 siemens.

12. A power supply circuit according to example 11, wherein the dry-susceptor threshold is at least 15 percent less than the target equivalent conductance, optionally at least 20 percent less than the target equivalent conductance, and optionally between about 15 percent and about 50 percent less than the target equivalent conductance.

13. A power supply circuit according to any one of examples 1 to 12, wherein the controller is further configured to measure the voltage between the power supply and the inductor coil.

14. A power supply circuit according to any one of examples 1 to 13, wherein the controller is further configured to measure the current between the power supply and the inductor coil.

15. A power supply circuit according to any one of examples 1 to 14, wherein the power supply is a DC power supply.

16. A power supply circuit according to example 15, further comprising a DC/AC converter arranged between the DC power supply and the inductor coil.

17. A power supply circuit according to example 16, wherein the DC/AC converter comprises a capacitor.

18. A power supply circuit according to example 16 or example 17, wherein the DC/AC converter comprises a LC (inductor capacitor) load network.

19. A power supply circuit according to example 16, wherein the DC/AC converter comprises a capacitor, wherein the DC/AC converter further comprises a LC (inductor capacitor) load network, and wherein the LC load network comprises the inductor coil and the capacitor, and optionally wherein the inductor coil is connected in series with the capacitor.

20. A power supply circuit according to any one of examples 16 to 19, wherein the DC/AC converter comprises a Class-E power amplifier.

21. A power supply circuit according to any one of examples 16 to 19, wherein the DC/AC converter comprises a Class-D power amplifier.

22. A power supply circuit according to any one of examples 1 to 21, further comprising a puff detector configured to detect when a user draws on the aerosol-generating device.

23. A power supply circuit according to example 22, wherein the controller is further configured to supply the current and the voltage to the inductor coil to generate the alternating magnetic field to heat the susceptor element and generate the aerosol when the puff detector detects a user drawing on the aerosol-generating device.

24. A power supply circuit according to example 23, wherein the controller is further configured to prevent the supply of the current and the voltage to the inductor coil to generate the alternating magnetic field to heat the susceptor element and generate the aerosol when it is determined that the susceptor element is not supplied with the liquid aerosol-forming substrate.

25. An aerosol-generating device configured to heat a susceptor element to generate an aerosol from a liquid aerosol-forming substrate supplied to the susceptor element, the aerosol-generating device comprising a power supply circuit according to any one of examples 1 to 24.

26. An aerosol-generating device configured to heat a susceptor element to generate an aerosol from a liquid aerosol-forming substrate supplied to the susceptor element, the aerosol-generating device being couplable to a cartridge comprising the susceptor element, and the aerosol-generating device comprising a power supply circuit comprising:
an inductor coil for generating an alternating magnetic field for heating the susceptor element to generate an aerosol from the liquid aerosol-forming substrate supplied to the susceptor element;
a power supply; and
a controller, wherein the controller is configured to:
   control at least one of a current and a voltage between the power supply and the inductor coil;
   compare at least one of the current and the voltage between the power supply and the inductor coil to a dry-susceptor threshold; and
   determine whether the susceptor element is supplied with the liquid aerosol-forming substrate based on the comparison.

27. An aerosol-generating device according to example 25 or example 26, further comprising a cavity configured to receive a portion of a cartridge to couple the cartridge to the aerosol-generating device.

28. An aerosol-generating device according to example 27, wherein the inductor coil is arranged at or around the cavity.

29. An aerosol-generating device according to example 27 or example 28, wherein the inductor coil is arranged to generate the alternating magnetic field in the cavity.

30. An aerosol-generating device according to any one of examples 27 to 29, wherein the inductor coil at least partially circumscribes the cavity.

31. An aerosol-generating system comprising:
a cartridge comprising a susceptor element and a liquid aerosol-forming substrate supplied to the susceptor element; and
an aerosol-generating device according to any one of examples 25 to 30.

32. An aerosol-generating system comprising:
a cartridge comprising:
   a susceptor element; and
   a liquid aerosol-forming substrate supplied to the susceptor element; and
   an aerosol-generating device couplable to the cartridge, and configured to heat the susceptor element to generate an aerosol from the liquid aerosol-forming substrate supplied to the susceptor element, the aerosol-generating device comprising a power supply circuit comprising: an inductor coil for generating an alternating magnetic field for heating the susceptor element to generate an aerosol from the liquid aerosol-forming substrate supplied to the susceptor element;
   a power supply; and
   a controller, wherein the controller is configured to:
   control at least one of a current and a voltage between the power supply and the inductor coil;
   compare at least one of the current and the voltage between the power supply and the inductor coil to a dry-susceptor threshold; and
   determine whether the susceptor element is supplied with the liquid aerosol-forming substrate based on the comparison.

33. An aerosol-generating system according to example 31 or example 32, wherein the cartridge further comprises a liquid transfer element arranged to supply the liquid aerosol-forming substrate to the susceptor element.

34. An aerosol-generating system according to any one of examples 31 to 33, wherein the susceptor element is a mesh susceptor element.

35. An aerosol-generating system according to any one of examples 31 to 34, wherein the aerosol-generating device comprises a cavity configured to receive a portion of a cartridge to couple the cartridge to the aerosol-generating device, and wherein the susceptor element is arranged in the cartridge in a position that is received in the cavity of the aerosol-generating device when the cartridge is coupled to the aerosol-generating device.

36. A method of operating an aerosol-generating device, the aerosol-generating device comprising a power supply and an inductor coil, and being configured to heat a susceptor element to generate an aerosol from a liquid aerosol-forming substrate supplied to the susceptor element, the method comprising:
controlling at least one of a current and a voltage between the power supply and the inductor coil;
comparing at least one of the current and the voltage between the power supply and the inductor coil to a dry-susceptor threshold; and
determining whether the susceptor element is supplied with the liquid aerosol-forming substrate based on the comparison.

37. A method according to example 36, further comprising notifying a user when it is determined that the susceptor element is not supplied with the liquid aerosol-forming substrate.

38. A method according to any one of examples 36 or 37, further comprising preventing the current being supplied from the power supply to the inductor coil when it is determined that the susceptor element is not supplied with the liquid aerosol-forming substrate.

39. A method according to any one of examples 36 to 38, further comprising controlling at least one of the current and the voltage from the power supply to the inductor coil such that a power of between about 6 Watts and about 12 Watts is supplied to the inductor coil, and optionally suppling between about 8 Watts and about 10 Watts to the inductor coil.

40. A method according to any one of example 36 to 39, further comprising determining an equivalent resistance, the equivalent resistance being the quotient of the voltage and the current, and wherein the comparing the at least one of the current and the voltage to the dry-susceptor threshold is a comparison of the equivalent resistance to the dry-susceptor threshold.

41. A method according to example 41, wherein the dry-susceptor threshold is at least 1.05 ohms, and optionally is between about 1.05 ohms and 2.20 ohms.

42. A method according to example 41 or example 42, further comprising controlling at least one of the current and the voltage from the power supply to the inductor coil corresponding to a target equivalent resistance, and optionally wherein the target equivalent resistance is between about 0.25 ohms and about 1.7 ohms.

43. A method according to example 42, wherein the dry-susceptor threshold is an equivalent resistance at least 15 percent greater than the target equivalent resistance, optionally at least 20 percent great than the target equivalent resistance, and optionally between 15 percent and 50 percent greater than the target equivalent resistance.

44. A method according to any one of examples 36 to 39, further comprising determining an equivalent conductance, the equivalent conductance being the quotient of the current and the voltage, and wherein the comparison of the at least one of the current and the voltage to a dry-susceptor threshold is a comparison of the equivalent conductance to the dry-susceptor threshold.

45. A method according to example 44, wherein the dry-susceptor threshold is no less than 0.95 siemens, and optionally is between about 0.70 siemens and about 0.95 siemens.

46. A method according to example 44 or example 45, further comprising controlling at least one of the current and the voltage from the power supply to the inductor coil corresponding to a target equivalent conductance, and optionally wherein the target equivalent conductance is between about 0.60 siemens and about 4.00 siemens.

47. A method according to example 46, wherein the dry-susceptor threshold is at least 15 percent less than the target equivalent conductance, optionally at least 20 percent less than the target equivalent conductance, and optionally between about 15 percent and about 50 percent less than the target equivalent conductance.

48. A method according to any one of examples 36 to 47, further comprising measuring the voltage between the power supply and the inductor coil.

49. A method according to any one of examples 36 to 48, further comprising measuring the current between the power supply and the inductor coil.

50. A method according to any one of examples 36 to 49, wherein the aerosol-generating device further comprises a puff detector, and the method further comprises detecting when a user draws on the aerosol-generating device using the puff detector.

51. A method according to example 50, further comprising supplying the current and the voltage to the inductor coil to generate the alternating magnetic field to heat the susceptor element and generate the aerosol when the puff detector detects a user drawing on the aerosol-generating device.

52. A method according to example 51, further comprising preventing the supply of the current and the voltage to the inductor coil to generate the alternating magnetic field to heat the susceptor element and generate the aerosol when it is determined that the susceptor element is not supplied with the liquid aerosol-forming substrate.

Examples will now be further described with reference to the figures in which:

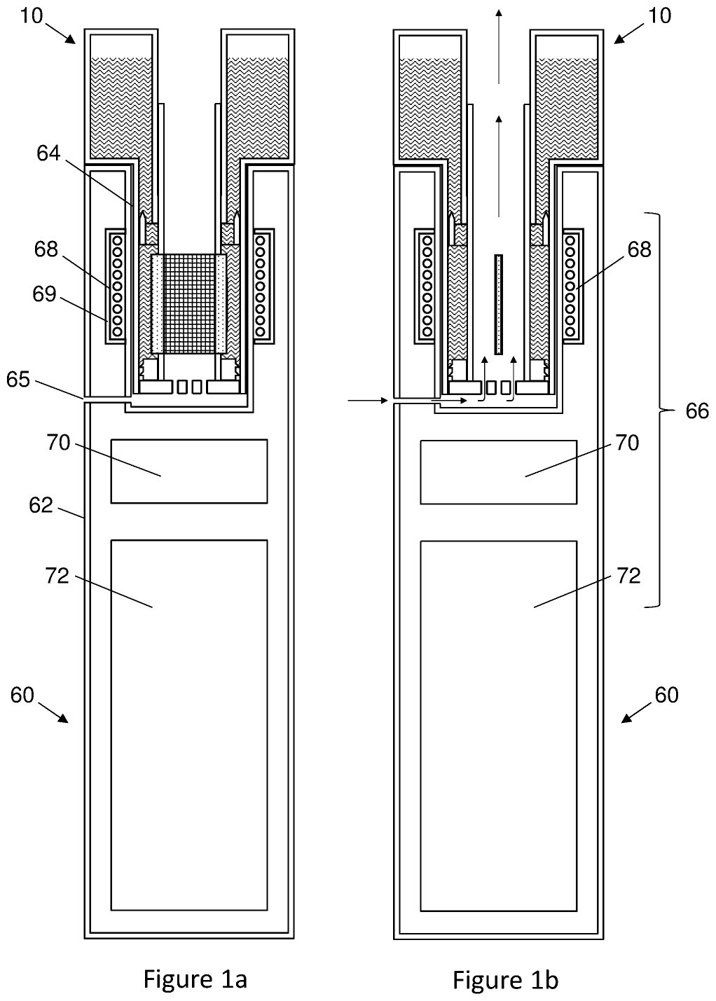

FIG. 1a shows a schematic illustration of an aerosol-generating system according to an example of the present disclosure, the aerosol-generating system comprising an aerosol-generating device and a cartridge;

FIG. 1b shows a schematic illustration of the aerosol-generating system of FIG. 1a rotated by 90 degrees about a central longitudinal axis of the aerosol-generating system;

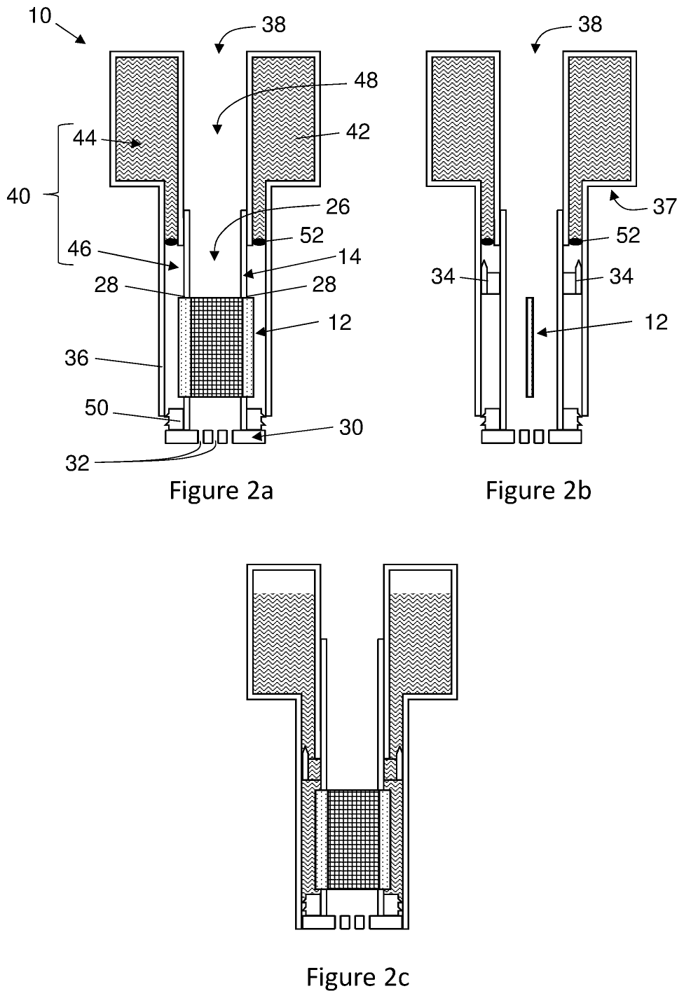

FIG. 2a shows a schematic illustration of a cartridge for an aerosol-generating system in accordance with an example of the present disclosure, wherein the cartridge is in a storage configuration;

FIG. 2b shows a schematic illustration of the cartridge of FIG. 2a rotated by 90 degrees about a central longitudinal axis of the cartridge;

FIG. 2c shows a schematic illustration of the cartridge of FIG. 2a, wherein the cartridge is in a use configuration;

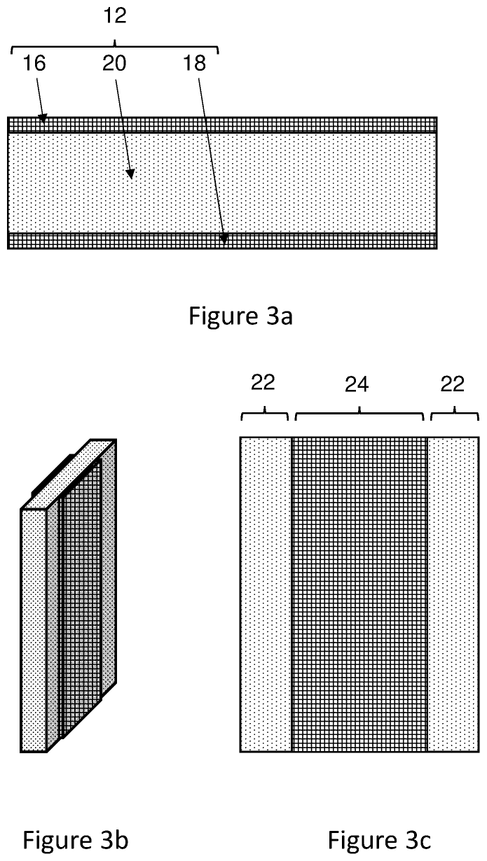

FIG. 3a shows a side view of a susceptor assembly of the cartridge of FIGS. 2a, 2b, and 2c;

FIG. 3b shows a perspective view of the susceptor assembly of FIG. 3a;

FIG. 3c shows a plan view of the susceptor assembly of FIG. 3a;

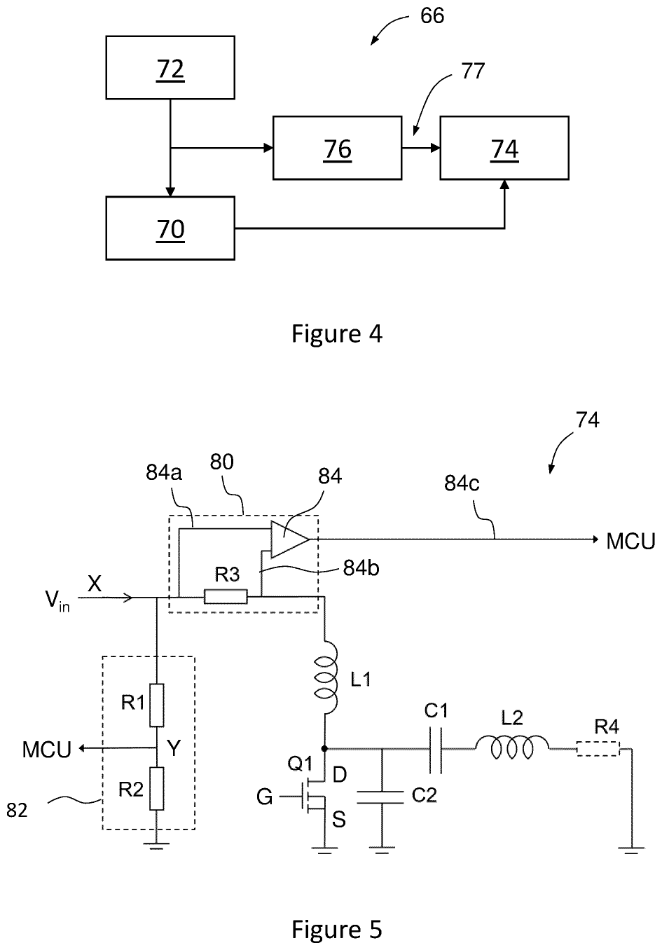

FIG. 4 shows a schematic block diagram of the power supply circuit of the aerosol-generating device of FIGS. 1a and 1b;

FIG. 5 shows a schematic circuit diagram of the heater module of the power supply circuit of FIG. 4;

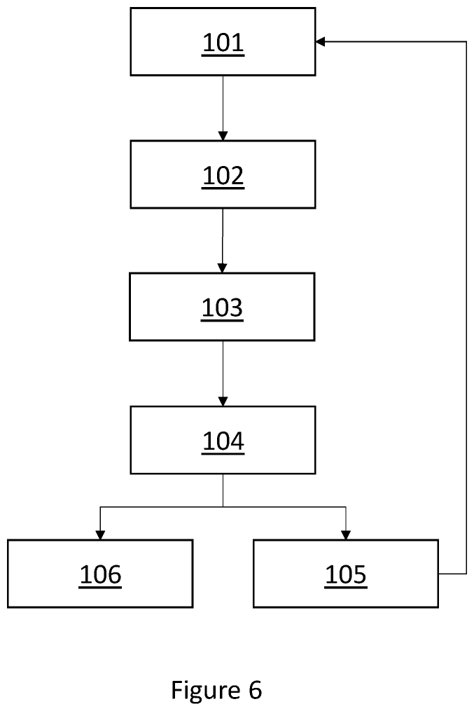

FIG. 6 shows a flow diagram of a simplified method of operating the power supply circuit of FIG. 4 according to an embodiment of the disclosure; and

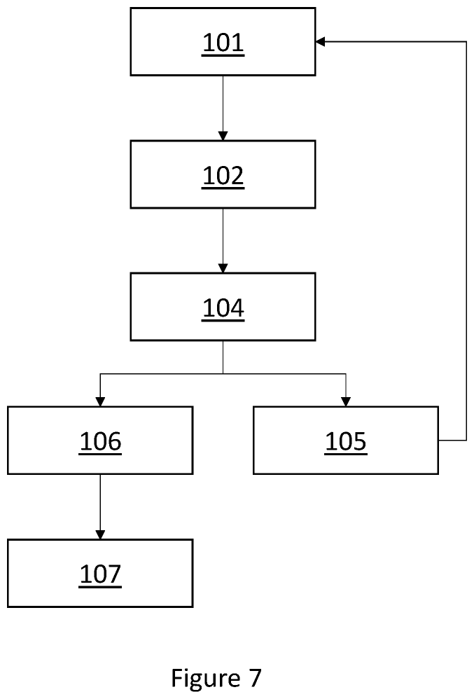

FIG. 7 shows a flow diagram of a simplified method of operating the power supply circuit of FIG. 4 according to another embodiment of the disclosure.

FIGS. 1a and 1b show a schematic illustration of an aerosol-generating system according to an example of the present disclosure. The aerosol-generating system comprises a cartridge 10 in a use configuration, received in an aerosol-generating device 60. The aerosol-generating system is portable and has a size comparable to a conventional cigar or cigarette.

FIGS. 2a, 2b and 2c show schematic illustrations of the cartridge 10 of FIGS. 1a and 1b. The cartridge 10 has a mouth end and a connection end, opposite the mouth end. The connection end is configured for connection of the cartridge 10 to an aerosol-generating device, as described in more detail below.

The cartridge 10 comprises an outer housing 36 formed from a mouldable plastics material, such as polypropylene. The outer housing 36 defines a mouth end opening 38 at the mouth end of the cartridge 10. The external width of the outer housing 36 is greater at the mouth end of the cartridge 10 than at the connection end, which are connected by a shoulder 37. This arrangement enables the connection end of the cartridge 10 to be received in a cavity 64 of the aerosol-generating device 60, with the shoulder 37 locating the cartridge 10 in the correct position in the device. This also enables the mouth end of the cartridge 10 to remain outside of the aerosol-generating device 60, with the mouth end conforming to the external shape of the aerosol-generating device 60.

The cartridge 10 further comprises a susceptor assembly 12 mounted in a susceptor element holder 14.

The susceptor assembly 12 is described in more detail below.

The susceptor element holder 14 comprises a tubular body formed from a mouldable plastic material, such as polypropylene. The tubular body of the susceptor element holder 14 comprises a side wall defining an internal passage 26, having open ends and a central longitudinal axis. A pair of openings 28 extend through the side wall, at opposite sides of the tubular susceptor element holder 14. The openings 28 are arranged centrally along the length of the susceptor element holder 14. The susceptor element holder 14 further comprises a base 30 that partially closes one end of the internal passage 26. The base 30 comprises a plurality of air inlets 32 that enable air to be drawn into the internal passage 26 through the partially closed end.

The outer housing 36 forms a first portion of the cartridge 10, and the susceptor assembly 12 and the susceptor element holder 14 form a second portion of the cartridge 10. The second portion of the cartridge is slidable relative to the first portion of the cartridge between a storage configuration, as shown in FIGS. 2a and 2b, and a use configuration, as shown in FIG. 2c. The susceptor assembly 12 and the susceptor element holder 14 are located towards the connection end of the cartridge 10.

A liquid reservoir 40 is defined in the cartridge 10 for holding a liquid aerosol-forming substrate 42. The liquid reservoir 40 is divided into two portions, a first portion 44 and a second portion 46. The first portion 44 is located towards the mouth end of the outer housing 36, and comprises an annular space defined by the outer housing 36. The annular space has an internal passage 48 that extends between the mouth end opening 38, and the open end of the internal passage 26 of the susceptor element holder 14. The second portion 46 of the liquid reservoir 40 is located towards the connection end of the outer housing 36, and comprises an annular space defined between an inner surface of the outer housing 36 and an outer surface of the susceptor element holder 14. The base 20 of the tubular susceptor element holder 14 is provided with an annular, ribbed, elastomeric seal 50 that extends between the outer surface of the tubular susceptor element 14 and the internal surface of the outer housing 36. The seal 50 provides a liquid tight seal between the susceptor element holder 14 and the outer housing 36.

The susceptor assembly 12 is shown in more detail in FIGS. 3a, 3b and 3c. The susceptor assembly 12 is planar, thin, and generally rectangular. The susceptor assembly 12 comprises three layers, a first susceptor element 16, a second susceptor element 18, and a wicking element 20 arranged between the first and second susceptor elements 16, 18. The first and second susceptor elements 16, 18 are substantially identical, and comprise a sintered mesh formed from filaments of SAE 410 stainless steel, a ferritic stainless steel. The wicking element 20 comprises a porous body of rayon filaments.

The first and second susceptor elements 16, 18, and the wicking element 20 each form a substantially rectangular sheet. The wicking element 20 is arranged between the first and second susceptor elements 16, 18, with the first and second susceptor elements 16, 18 arranged opposite each other, and centrally relative to the wicking element 20. The wicking element 20 has a length that is substantially the same as the length of the first and second susceptor elements 16, 18, and a width that is greater than the width of the first and second susceptor elements 16, 18. Two outer edge portions 22 of the wicking element 20 are not covered by the first and second susceptor elements 16, 18. Accordingly, the susceptor assembly 12 comprises a pair of mounting regions 22 formed by the uncovered edge portions of the wicking element 20. The susceptor assembly 12 also comprises a heating region 24 formed by the central region comprising the first and second susceptor elements 16, 18, and a central portion of the wicking element 20 between the first and second susceptor elements 16, 18.

The wicking element 20 is configured to supply liquid aerosol-forming substrate to the first and second susceptor elements 16, 18 from the exposed outer edge portions 22. The heating region 24 is configured to be heatable by penetration with an alternating magnetic field, for vaporising aerosol-forming substrate supplied to the susceptor elements 16, 18 by the wicking element 20.

The pair of mounting regions 22 are configured to extend into the liquid reservoir 40 of the cartridge 10 to convey liquid aerosol-forming substrate from the reservoir 40 to the first and second susceptor elements 16, 18. The pair of mounting regions 22 are also configured to contact the susceptor element holder 14, such that the susceptor element holder 14 can support the susceptor assembly 12 in position in the cartridge 10.

The heating region 24 of the susceptor assembly is arranged entirely within the internal passage 26 of the susceptor element holder 14, and each of the mounting regions 22 extends through one of the openings 28 in the side wall of the susceptor element holder 14. The openings 28 in the side wall of the susceptor element holder 14 are sized to accommodate the susceptor assembly 12 with a friction fit, such that the susceptor assembly is secured in the susceptor element holder 14. The susceptor assembly 12 extends substantially in a plane parallel to the central longitudinal axis of the susceptor element holder 14.

The susceptor element holder 14 further comprises a pair of piercing elements 34 extending from an outer surface of the side wall, towards the open end of the susceptor element holder 14, opposite the end partially closed by the base 30. The openings 28 in the sidewall of the susceptor element holder 14 are arranged between the piercing elements 34 around the circumference of the side wall, such that the piercing elements 34 are offset from the openings 28 around the circumference of the side wall of the tubular susceptor element by about 90 degrees. Each of the piercing elements 34 comprises a spike facing in the direction of the open end of the susceptor element holder 14.

An air passage is formed through the cartridge 10 by the internal passage 26 of the susceptor element holder 14, and the internal passage 48 through the first portion 44 of the liquid reservoir 40. The air passage extends from the air inlets 32 in the base 30 of the susceptor element holder 14, through the internal passage 26 of the susceptor element holder 14, and through the internal passage 48 of the first portion 44 of the liquid reservoir 40 to the mouth end opening 38. The air passage enables air to be drawn through the cartridge 10 from the connection end to the mouth end.

When the cartridge is in the storage configuration, as shown in FIGS. 2a and 2b, the base 30 of the susceptor element holder 14 extends out of the outer housing 36. The first and second portions 44, 46 of the liquid reservoir 40 are fluidly isolated from each other by an aluminium foil seal 52, and the piercing elements 34 of the susceptor element holder 14 are spaced from the seal 52 in the direction of the connection end of the cartridge 10. In this configuration, the liquid aerosol-forming substrate 42 is held in the first portion 44 of the liquid reservoir 40 and is isolated from the second portion 46 of the liquid reservoir 40, and the susceptor assembly 12, by the seal 52.

In the use configuration, as shown in FIG. 2c, the susceptor element holder 14 and the susceptor assembly 12 are pushed into the outer housing 36, towards the mouth end. As the susceptor element holder 14 is pushed towards the mouth end of the outer housing 36, the seal 52 at the base 30 of the susceptor element holder 14 slides over the inner surface of the outer housing 36, establishing a liquid tight seal between the inner surface of the outer housing 36 and the outer surface of the tubular susceptor element holder body. As the susceptor element holder 14 is moved towards the mouth end, the piercing elements 34 contact and pierce the seal 52, allowing fluid communication between the first portion 44 of the liquid reservoir 40, and the second portion 46 of the liquid reservoir 40. The liquid aerosol-forming substrate 42 in the first portion 44 of the liquid reservoir 40 is released into the second portion 46 of the liquid reservoir 40, and the susceptor assembly 12 is exposed to the liquid aerosol-forming substrate 42.

In the use configuration, the mounting regions 22 of the wicking element 20 that extend into the second portion 46 of the liquid reservoir 40 are able to draw the liquid aerosol-forming substrate 42 from the second portion 46 of the liquid reservoir 40 to the first and second susceptor elements 16, 18. As a result, in the use configuration, the first and second susceptor elements are supplied with liquid aerosol-forming substrate 42, and the cartridge 10 is ready for use to generate an aerosol by heating the liquid aerosol-forming substrate 42.

As shown in FIGS. 1a and 1b, the aerosol-generating device 60 comprises a generally cylindrical housing 62 having a connection end and a distal end opposite the connection end. A cavity 64 for receiving the connection end of the cartridge 10 is located at the connection end of the device 60, and an air inlet 65 is provided through the outer housing 62 at the base of the cavity 64 to enable ambient air to be drawn into the cavity 64 at the base.

The device 60 further comprises a power supply circuit 66. The power supply circuit 66 includes an inductor coil 68, a controller 70, and a power supply 72. The power supply 72 comprises a rechargeable lithium iron phosphate battery, having a DC supply voltage of 3.2 Volts that is rechargeable via an electrical connector (not shown) at the distal end of the device. The controller 70 is connected to the power supply 72, and to the inductor coil 68, such that the controller 70 controls the supply of power to the inductor coil 68. The power supply circuit 66 is configured to supply an alternating current to the inductor coil 68.

The inductor coil 68 comprises a helical coil that circumscribes the cavity 64. When the cartridge 10 is received in the cavity 64, the first and second susceptor elements 16, 18 are also circumscribed by the inductor coil 68.

The inductor coil 68 is configured such that when an alternating current is supplied to the inductor coil 68, the inductor coil 68 generates an alternating magnetic field in the cavity 64, which penetrates the first and second susceptor elements 16, 18 when the cartridge 10 is received in the cavity 64.

The aerosol-generating device 60 further includes a flux concentrator element 69. The flux concentrator element 69 has a greater radius than the inductor coil 68, and so partially surrounds the inductor coil 68. The flux concentrator element 69 is configured to reduce the stray power losses from the generated magnetic field.

In operation, when a user puffs on the mouth end opening 38 of the cartridge 10, ambient air is drawn into the base of the cavity 64 through air inlet 65, and into the cartridge 10 through the air inlets 32 in the base 30 of the cartridge 10, as shown by the arrows in FIG. 1b. The ambient air flows through the cartridge 10 from the base 30 to the mouth end opening 38, through the air passage, and over the susceptor assembly 12.

The controller 70 controls the supply of electrical power from the power supply 72 to the inductor coil 68 when the system is activated. The controller 72 includes a puff detector, in the form of an airflow sensor (not shown), and the controller 72 supplies electrical power to the inductor coil 68 when user puffs on the cartridge 10 are detected by the puff detector.

When the system is activated, an alternating current is established in the inductor coil 68, which generates an alternating magnetic field in the cavity 64 that penetrates the first and second susceptor elements 16, 18, causing the first and second susceptor elements 16, 18 to heat. Liquid aerosol-forming substrate in the second portion 44 of the liquid reservoir 40 is supplied to the first and second susceptor elements 16, 18 by the wicking element 20. The liquid aerosol-forming substrate supplied to the first and second susceptor elements 16, 18 is heated, and volatile compounds from the heated aerosol-forming substrate are released into the air passage of the cartridge 10, which cool to form an aerosol. The aerosol is entrained in the air being drawn through the air passage of the cartridge 10 and is drawn out of the cartridge 10 at the mouth end opening 38 for inhalation by the user.

FIG. 4 is a schematic block diagram showing a power supply circuit 66, according to an embodiment of the disclosure, for the aerosol-generating device 60 of FIGS. 1a and 1b. The power supply circuit 66 comprises the microcontroller 70, the battery 72, and a heater engine or heater module 74 comprising the inductor coil 68. In the present example, the microcontroller 70, together with other electronic components and the heater module 74, are mounted on the same printed circuit board (not shown), although it will be appreciated that the heater module 74 could be provided on a separate dedicated printed circuit board.

The microcontroller 70 is provided to control the heater module 74 and, in particular, the electrical power delivered to the induction coil 68, which is inductively coupled to the first and second susceptor elements 16, 18 in the cartridge 10, when the cartridge 10 is coupled with the aerosol-generating device 60 as shown in FIGS. 1a and 1b. The microcontroller 70 is further provided for controlling the general operation of the aerosol-generating device 60 and is connected to various other electronic components (not shown) of the aerosol-generating device 60 to enable it to perform this function. For example, such other electronic components may include sensors, a user interface such as LEDs or an LCD screen for displaying information to a user and a switch for activating the aerosol-generating device 60, means for providing a data connection with external devices, and charging circuitry for recharging the battery 72.

In this example, a single microcontroller 70 is provided to control all of the features of the aerosol-generating device 60. However, it will be appreciated that in some embodiments several microcontrollers may be provided, each microcontroller controlling different features of the aerosol-generating device 60. For example, a first microcontroller may be provided to control the heater module, and a second microcontroller may be provided to control the general operation of the aerosol-generating device. In this example, the first microcontroller may be part of the heater module and may be dedicated to controlling the electrical power delivered to the induction coil of the heater module. An advantage of the heater module having its own microcontroller is that it may help to make the heater module reusable in different devices because it can be programmed with its own firmware for controlling the heating process, and there is no need to include firmware relating to heating in other components. This may enable the heater module to be a standalone unit or module which can be integrated into various different devices.

As will be discussed in more detail below with reference to FIG. 5, the heater module 74 comprises drive circuitry (not shown in FIG. 4) for driving the induction coil 68 to heat the first and second susceptor elements 16, 18 in the cartridge 10. The heater module 74 also comprises a DC/AC voltage converter (not shown in FIG. 4), which is connected to the drive circuitry, and converts the DC voltage fed to the driving circuitry to an AC voltage in order to generate an alternating current in the induction coil 68, which in turn causes the induction coil 68 to produce an alternating or alternating magnetic field. In this example, the induction coil 68 is part of the DC/AC voltage converter. This arrangement helps to reduce the number of electrical components required. However, it will be appreciated that the induction coil 68 could be separate to the DC/AC voltage converter, although this may necessitate additional components in order to generate an AC voltage. The DC/AC voltage converter also comprises a matching network (not shown in FIG. 4), which is configured to operate at low ohmic load, and helps to match the output impedance of the DC/AC converter to the load represented by resistive losses in the induction coil and the apparent resistance of the susceptor elements 16, 18.

The power supply circuit 66 further comprises a DC/DC voltage converter 76, which is configured to convert a DC supply voltage Vsupply from the battery 72 and output a constant voltage of 2.95 Volts at a voltage converter output 77. The voltage converter output 77 is connected to the heater module 74 and provides the voltage input to the heater module 74. Therefore, the output voltage from the DC/DC voltage converter 76 constitutes a heater module input voltage Vin. The heater. dule input voltage Vin is used to power the heater module 74. This heater module input voltage is selected to provide a predetermined heating performance based on the particular components of the heater module. It will be appreciated that different heater module input voltages could be used to provide different heating performance and the DC/DC voltage converter 76 can be configured to output different voltages. However, once the heater module input voltage Vin has been set, significant changes to the heater module input voltage Vin would change the power delivered to the induction coil and may lead to undesirable variation in heating performance. Furthermore, a number of the component parameters of the heater module 74 are sensitive to the input voltage and changing the heater module input voltage Vin may lead to instability. Therefore, the DC/DC voltage converter 76 helps to reduce variability and improve stability by providing a constant heater module input voltage Vin. For clarity, the DC/DC voltage converter 76 has been shown as a separate component in this example, but it may be part of the heater module 74.

The power supply circuit 66 of FIG. 4 in the aerosol-generating device 60 of FIGS. 1a and 1b would converts the DC supply voltage of the lithium iron phosphate battery 72 of 3.2 Volts to a constant heater module input voltage of 2.95 Volts. In this case, the DC/DC voltage converter 76 helps to maintain a constant heater module input voltage Vin but the heater module 74 could function relatively normally with a 3.2 Volt supply from the lithium iron phosphate battery 72 in the absence of the DC/DC voltage converter 76 because this supply voltage is not too dissimilar from the heater module input voltage of 2.95 Volts. However, it will be appreciated that the heater module 74 could be used in different aerosol-generating devices using batteries having different battery chemistries. For example, the aerosol-generating device 60 of FIGS. 1a and 1b could use a lithium nickel manganese cobalt oxide battery having a DC supply voltage of 4.2 Volts. In this case, the DC/DC voltage converter 76 allows the heater module 74 to perform in a similar manner to how the heater module 74 would perform using a lithium iron phosphate battery 72 to supply voltage directly without the DC/DC voltage converter 76 by converting this higher DC supply voltage to 2.95 Volts. Indeed, the DC/DC voltage converter 76 is configured to accept a range of DC supply voltages and output a constant heater module input voltage. Therefore, the DC/DC voltage converter 76 of the heater module 74 allows different types of battery to be used having a range of DC supply voltages.

FIG. 5 shows part of the power supply circuit 66 of FIG. 4 in more detail, in particular, the heater module 74 of FIG. 4. The circuit of FIG. 5 is powered by the output voltage 77 from the DC/DC voltage converter 76 of FIG. 4, that is, the heater module input voltage Vin, which is received at a point X in FIG. 5. The heater module 74 comprises a transistor switch Q1 and a first inductor L1, which act as drive circuitry for driving the induction coil 68, and a DC/AC voltage converter. The transistor switch Q1 comprises a field effect transistor (FET), for example, a metal-oxide semiconductor field effect transistor (MOSFET) and the first inductor L1 comprises a radio frequency choke. The heater module input voltage Vin is fed to transistor switch Q1 via resistor R3 (discussed in more detail below) and the first inductor L1. The first inductor L1 helps to reduce radio frequencies which may be present at the input X from entering the circuit. The gate G of the transistor switch Q1 is connected to the microcontroller 70 of FIG. 4 and receives a switching signal from the microcontroller 70 to turn the transistor switch Q1 ON and OFF. The switching signal is a square wave having a substantially 50% duty cycle.

The heater module 74 further comprises a first capacitor C1 connected in series with a second inductor L2, which corresponds to the induction coil 68. A second capacitor C2 is connected between the drain D of transistor switch Q1 and electrical ground, and acts as a shunt capacitor. The first capacitor C1, second inductor L2, and second capacitor C2 define a DC/AC voltage converter for converting the switching signal passed to the transistor switch Q1 into an AC voltage across an equivalent resistance R4. Equivalent resistance R4 is equivalent to the ohmic resistance R_{coil} of the second inductor L2 connected in series with the apparent ohmic resistance Ra of the susceptor element 16, 18. Resistance R4 is shown in dotted outline in FIG. 5 to indicate that it is an equivalent resistance of the second inductor L2 and the susceptor elements 16, 18, rather than an actual resistor in the circuit.

Together, the first inductor L1, transistor switch Q1, first capacitor C1, second inductor L2, and second capacitor C2 form a Class-E power amplifier. The general operating principle of the Class-E power amplifier is known and is described in detail in the article “Class-E RF Power Amplifiers”, Nathan 0. Sokal, published in the bimonthly magazine QEX, edition January/February 1001, pages 9-20, of the American Radio Relay League (ARRL), Newington, CT, U.S.A. and therefore, will not be discussed further here.

It has been found that using a Class-E amplifier to power the second inductor L2 is highly efficient. This is because, due to the configuration of the circuit, current flow through transistor switch Q1 does not occur at the same time as there is voltage across the transistor switch Q1. Accordingly, substantially no energy is dissipated in transistor switch Q1, and instead substantially all the power is fed to the load equivalent resistance R4. Furthermore, the first capacitor C1 and second inductor L2 form a series resonant circuit, which is tuned to the switching frequency of the switching signal. The first capacitor C1 and second inductor L2 act as a bandpass filter which allows an AC voltage signal to be transferred to the load equivalent resistance R4 only at the desired operating frequency of the second inductor L2. This means that power is transferred to the load equivalent resistance R4 only at the switching frequency of the switching signal, and any harmonic frequencies are significantly suppressed, which helps to further improve efficiency.

In addition, the second inductor L2 and capacitors C1 and C2 form a LC load network, or matching network, which is configured to operate at low ohmic load, and helps to match the output impedance of the DC/AC converter to the load equivalent resistance R4. In particular, the capacitors C1 and C2 have been tuned to reduce the ohmic load of the second inductor L2 relative to the susceptor elements 16, 18 so that more heat is dissipated in the susceptor elements 16, 18 compared to the inductor L2, which is what is desired for heating the aerosol-forming substrate.

The heater module 74 comprises relatively few components compared to other power supply circuits for aerosol-generating devices, and therefore the printed circuit board area required for mounting these components can be kept small, which helps to reduce the overall dimensions of the aerosol-generating device 60. Furthermore, by using the second inductor L2 in the DC/AC conversion, the number of components is further reduced.

During operation, the second inductor L2 generates an alternating magnetic field that induces eddy currents in the susceptor elements 16, 18 of the cartridge 10, heating the susceptor elements 16, 18. As the susceptor elements 16, 18 are heated during operation, liquid aerosol-forming substrate supplied to the susceptor elements 16, 18 from the liquid reservoir 40, via the liquid transfer element 20, is vaporised.

The inventors have recognised that while liquid aerosol-forming substrate is being supplied to the susceptor elements 16, 18, and the liquid aerosol-forming substrate is being vaporised, the apparent resistance Ra of the susceptor elements 16, 18 remains substantially constant. However, if the supply of liquid aerosol-forming substrate to the susceptor elements 16, 18 reduces, or stops, as the liquid reservoir is depleted, the apparent resistance Ra of the susceptor elements 16, 18 increases, causing the equivalent resistance R4 to increase, and the DC current IDC drawn by the heater module 74 at a constant voltage to decrease.

The circuit of FIG. 5 further comprises two sensor circuits for determining the equivalent resistance Re, or the equivalent conductance G4, of the equivalent resistance R4: current sensor circuit 80, and voltage sensor circuit 82.

The current sensor circuit 80 comprises a current sensor in the form of resistor R3, which has a known value. The resistor R3 is connected in series between point X (which receives the heater module input voltage Vin) and the first inductor L1. Therefore, during operation, the DC current IDC passing through resistor R3 is substantially the same as the current being drawn by the heater module 74. As discussed above, the circuit of FIG. 5 is powered by the output voltage from the DC/DC voltage converter 76 of FIG. 4. Therefore, the DC current IDC passing through resistor R3 is equal to the DC current supplied by the DC/DC voltage converter. Resistor R3 has an appropriately low resistance value to help to reduce resistive losses.

The current sensor circuit 80 further comprises a differential amplifier 84 having two inputs, 84a and 84b, which are connected at either side of the resistor R3, and therefore receive voltage signals from either side of the resistor R3. The differential amplifier 84 has an output, 84c, which outputs a voltage that is proportional to the difference between the voltages received at the inputs 84a and 84b, that is, a voltage drop VR3 across resistor R3. The output 84c of differential amplifier 84 is connected to an analogue-to-digital converter (ADC) input of a microcontroller (MCU), which in this example is the microcontroller 70 of FIG. 4. Therefore, based on the signal received from the output 84c of the differential amplifier 84, the microcontroller 70 is configured to determine the voltage drop VR3 across resistor R3. Since the resistor R3 has a known value, the DC current IDC through resistor R3 which is fed to the heater module 74 can be determined by the microcontroller 70 through application of Ohm's law, as shown in equation (1):

$${I}_{DC} = {V}_{R 3} / R 3 \qquad ( 1 )$$

The voltage sensor circuit 82 comprises a first resistor R1, and a second resistor R2 connected in series between point X in FIG. 5, where the heater module input voltage Vin is received, and electrical ground. Resistors R1 and R2 form a voltage divider, or potential divider, and have equal resistance values so that the voltage at a point Y between resistors R1 and R2 is equal to half the heater module input voltage Vin. Point Y is connected to an analogue-to-digital converter (ADC) input of a microcontroller (MCU), that is, the microcontroller 70 of FIG. 4, to provide a voltage signal corresponding to the voltage at point Y to the microcontroller 70. This allows the microcontroller 70 to determine the heater module input voltage Vin by multiplying the voltage signal received from point Y by two. It will be appreciated that other resistance values could be used for resistors R1 and R2 but that this would involve a corresponding adjustment to the voltage calculation performed by the microcontroller. Resistors R1 and R2 have relatively high resistance values to reduce current draw through the potential divider.

The voltage sensor circuit 82 is optional, because, as mentioned above, the heater module input voltage Vin corresponds to the constant voltage output from the DC/DC voltage converter 76 in FIG. 4. Therefore, the heater module input voltage Vin is already known, and is constant, and therefore can be stored as a value in the memory of the microcontroller 70. However, the provision of the voltage sensor circuit 82 allows the heater module input voltage Vin to be checked to confirm it is the same as the one stored in memory. The provision of the voltage sensor circuit 82 negates the need to store the heater module input voltage Vin in memory, thereby simplifying the programming of the microcontroller 70.

As mentioned above, a Class-E power amplifier has been found to be a highly efficient means for transferring power to the load equivalent resistance R4. Consequently, the DC current IDC through resistor R3 is indicative of the current being supplied to the load equivalent resistance R4. Furthermore, the resistance value of resistor R3 is relatively small, and therefore the voltage drop across resistor R3 can be substantially ignored. Therefore, the value of the load equivalent resistance R4 can be determined by the microcontroller 70 by application of Ohm's law, as shown in equation (2):

$$R 4 = {V}_{in} / {1}_{DC} \qquad ( 2 )$$

Equation (2) above can be rewritten as shown in equation (3) below to give the equivalent conductance G4 of the load equivalent resistance R4:

$$G 4 = {I}_{DC} / {V}_{in} \qquad ( 3 )$$

The equivalent conductance G4 is the reciprocal of the equivalent resistance R4. An advantage of determining the equivalent conductance G4 in accordance with equation (3) is that conductance is indicative or directly related to the DC current IDC when the voltage Vin is constant, which it is in this case because Vin is provided by the DC/DC voltage converter 76 of FIG. 4. Therefore, the current being supplied by the DC/DC voltage converter, and being measured by the current sensor circuit 80, provides a direct indication of the equivalent conductance G4 of the load equivalent resistance R4. As a result, the measured value of the DC current IDC can be used by the microcontroller 70 as a proxy for the value of the equivalent conductance G4 without having to determine the equivalent conductance G4 or the equivalent resistance R4, thereby reducing and simplifying the calculations which need to be performed.

FIG. 6 shows a flow diagram of a simplified method of operating the power supply circuit 66 according to an embodiment of the disclosure.

In a first step, 101, the microcontroller 70 is configured to control the switching signal to turn the transistor switch Q1 ON and OFF to control the current and the voltage between the power supply 72 and the inductor coil L2.

In a second step, 102, the microcontroller 70 is configured to measure the current being supplied by the DC/DC voltage converter 76, via the output of the current sensor 80, and is configured to measure the heater module input voltage Vin by multiplying the voltage signal received from the voltage sensor circuit 82 by two.

In a third step, 103, the microcontroller 70 is configured to determine the equivalent resistance R4 by calculating the quotient of the heater module input voltage Vin and the current being supplied by the DC/DC voltage converter 76.

In a fourth step, 104, the microcontroller 70 is configured to compare the determined equivalent resistance R4 to a dry susceptor threshold stored in a memory of the microcontroller 70.

In a fifth step, 105, if the microcontroller 70 determines that the determined equivalent resistance R4 is equal to or less than the dry-susceptor threshold, the microcontroller 70 is configured to determine that the susceptor elements 16, 18 are supplied with liquid aerosol-forming substrate, and is configured to revert to the first step 101.

In a sixth step, 106, if the microcontroller 70 determines that the determined equivalent resistance R4 is greater than the dry-susceptor threshold, the microcontroller 70 is configured to determine that the susceptor elements 16, 18 are not supplied with liquid aerosol-forming substrate, and is configured to notify a user that the susceptor element is not supplied with sufficient liquid aerosol-forming substrate. In this embodiment, the notification comprises the microcontroller 70 illuminating a light emitting diode (not shown).

FIG. 7 shows a flow diagram of a simplified method of operating the power supply circuit 66 according to another embodiment of the disclosure.

In a first step, 101, the microcontroller 70 is configured to control the switching signal to turn the transistor switch Q1 ON and OFF to control the current and the voltage between the power supply 72 and the inductor coil L2.

In a second step, 102, the microcontroller 70 is configured to measure the current being supplied by the DC/DC voltage converter 76, via the output of the current sensor 80.

In a third step, 104, the microcontroller is configured to compare the measured current supplied by the DC/DC voltage converter 76 to a dry susceptor threshold stored in a memory of the microcontroller 70. In this embodiment, the current supplied by the DC/DC voltage converter 76 is used as a proxy for the value of the equivalent conductance G4 of the load equivalent resistance R4.

In a fourth step, 105, if the microcontroller 70 determines that the measured current is greater than or equal to the dry-susceptor threshold, the microcontroller 70 is configured to determine that the susceptor elements 16, 18 are supplied with liquid aerosol-forming substrate, and is configured to revert to the first step 101.

In a fifth step, 106, if the microcontroller 70 determines that the measured current is less than the dry-susceptor threshold, the microcontroller 70 is configured to determine that the susceptor elements 16, 18 are not supplied with liquid aerosol-forming substrate, and is configured to notify a user that the susceptor element is not supplied with sufficient liquid aerosol-forming substrate. In this embodiment, the notification comprises the microcontroller 70 illuminating a light emitting diode (not shown).

In a sixth step, 107, if the microcontroller 70 determines that the measured current is equal to or greater than the dry-susceptor threshold, the microcontroller 70 is configured to control the switching signal to turn the transistor switch to prevent the current and the voltage between the power supply 72 and the inductor coil L2.

For the purpose of the present description, and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±{5%} of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. A power supply circuit for an aerosol-generating device, the aerosol-generating device being configured to heat a susceptor element to generate an aerosol from a liquid aerosol-forming substrate supplied to the susceptor element, the power supply circuit comprising:
an inductor coil configured to generate an alternating magnetic field for heating the susceptor element to generate an aerosol from the liquid aerosol-forming substrate supplied to the susceptor element;
a power supply; and
a controller configured to:
control at least one of a current and a voltage between the power supply and the inductor coil,
compare at least one of a current and a voltage between the power supply and the inductor coil to a dry-susceptor threshold, and
determine whether the susceptor element is supplied with the liquid aerosol-forming substrate based on the comparison.

17. The power supply circuit according to claim 16, wherein the controller is further configured to notify a user when it is determined that the susceptor element is not supplied with the liquid aerosol-forming substrate.

18. The power supply circuit according to claim 16, wherein the controller is further configured to prevent the current being supplied from the power supply to the inductor coil when it is determined that the susceptor element is not supplied with the liquid aerosol-forming substrate.

19. The power supply circuit according to claim 16, wherein the controller is further configured to control at least one of the current and the voltage from the power supply to the inductor coil such that a power of between about 6 Watts and about 12 Watts is supplied to the inductor coil.

20. The power supply circuit according to claim 16, wherein the controller is further configured to control at least one of the current and the voltage from the power supply to the inductor coil such that a power of between about 8 Watts and about 10 Watts is supplied to the inductor coil.

21. The power supply circuit according to claim 16,
wherein the controller is further configured to determine an equivalent resistance, the equivalent resistance being the quotient of the voltage and the current, and
wherein the comparison of the at least one of the current and the voltage to the dry-susceptor threshold is a comparison of the equivalent resistance to the dry-susceptor threshold.

22. The power supply circuit according to claim 21, wherein the dry-susceptor threshold is at least 1.05 ohms.

23. The power supply circuit according to claim 21, wherein the dry-susceptor threshold is between about 1.05 ohms and 2.20 ohms.

24. The power supply circuit according to claim 21, wherein the controller is further configured to control at least one of the current and the voltage from the power supply to the inductor coil corresponding to a target equivalent resistance.

25. The power supply circuit according to claim 24, wherein the target equivalent resistance is between about 0.25 ohms and about 1.7 ohms.

26. The power supply circuit according to claim 24, wherein the dry-susceptor threshold is an equivalent resistance at least 15 percent greater than the target equivalent resistance.

27. The power supply circuit according to claim 16,
wherein the controller is further configured to determine an equivalent conductance, the equivalent being the quotient of the current and the voltage, and
wherein the comparison of the at least one of the current and the voltage to a dry-susceptor threshold is a comparison of the equivalent conductance to the dry-susceptor threshold.

28. The power supply circuit according to claim 27, wherein the dry-susceptor threshold is no less than 0.95 siemens.

29. The power supply circuit according to claim 27, wherein the dry-susceptor threshold is between about 0.70 siemens and about 0.95 siemens.

30. The power supply circuit according to claim 27, wherein the controller is further configured to control at least one of the current and the voltage from the power supply to the inductor coil corresponding to a target equivalent conductance.

31. The power supply circuit according to claim 30, wherein the target equivalent conductance is between about 0.60 siemens and about 4.00 siemens.

32. The power supply circuit according to claim 30, wherein the dry-susceptor threshold is at least 15 percent less than the target equivalent conductance.

33. An aerosol-generating device configured to heat a susceptor element to generate an aerosol from a liquid aerosol-forming substrate supplied to the susceptor element, the aerosol-generating device being couplable to a cartridge comprising the susceptor element, and the aerosol-generating device comprising a power supply circuit comprising:
an inductor coil configured to generate an alternating magnetic field for heating the susceptor element to generate an aerosol from the liquid aerosol-forming substrate supplied to the susceptor element;
a power supply; and
a controller configured to:
control at least one of a current and a voltage between the power supply and the inductor coil,
compare at least one of the current and the voltage between the power supply and the inductor coil to a dry-susceptor threshold, and
determine whether the susceptor element is supplied with the liquid aerosol-forming substrate based on the comparison.

34. An aerosol-generating system, comprising:
a cartridge comprising:
a susceptor element, and
a liquid aerosol-forming substrate supplied to the susceptor element; and
an aerosol-generating device couplable to the cartridge, and configured to heat the susceptor element to generate an aerosol from the liquid aerosol-forming substrate supplied to the susceptor element, the aerosol-generating device comprising a power supply circuit comprising:
an inductor coil configured to generate an alternating magnetic field for heating the susceptor element to generate an aerosol from the liquid aerosol-forming substrate supplied to the susceptor element,
a power supply, and
a controller configured to:
control at least one of a current and a voltage between the power supply and the inductor coil,
compare at least one of the current and the voltage between the power supply and the inductor coil to a dry-susceptor threshold, and
determine whether the susceptor element is supplied with the liquid aerosol-forming substrate based on the comparison.

35. A method of operating an aerosol-generating device, the aerosol-generating device comprising a power supply and an inductor coil, and being configured to heat a susceptor element to generate an aerosol from a liquid aerosol-forming substrate supplied to the susceptor element, the method comprising:
controlling at least one of a current and a voltage between the power supply and the inductor coil;
comparing at least one of the current and the voltage between the power supply and the inductor coil to a dry-susceptor threshold; and
determining whether the susceptor element is supplied with the liquid aerosol-forming substrate based on the comparison.
